(19) United States
(12) Patent Application Publication
(10) Pub. No.: US 2010/0019484 A1
(43) Pub. Date: Jan. 28, 2010

(54) COMPRESSION FITTING ADJUSTMENT SYSTEM

(76) Inventor: Kenneth P. Krohn, Oceanside, CA (US)

Correspondence Address: LAW OFFICE OF KENNETH P. KROHN,;A PROFESSIONAL LAW CORPORATION, POST OFFICE BOX 4415, CARLSBAD, CA, 92018, US

(21) Appl. No.: 12/506,640

(22) Filed: Jul. 21, 2009

Related U.S. Application Data
(60) Provisional application No. 61/135,701, filed on Jul. 23, 2008.

(51) Int. Cl. F16L 33/16; B23P 11/00; F16L 25/00

(52) U.S. Cl. 285/104; 29/428; 285/334.2

(57) ABSTRACT

The present invention generally relates to a size adjusting device that may be used with compression connectors, such as compression couplings and fittings, that are designed to be connected to at least one duct (such as a pipe or tubing). Such compression connectors are typically comprised of at least one compression member, which is compressed between a casing member and the duct, forming a fluid-tight seal between the duct and the compression connector. The size adjusting device may be positioned between the compression connector and a smaller duct, so that fluid-tight seals are formed between the smaller duct, the size adjusting device, and the compression connector. This allows the compression connector to be connected to ducts that are smaller than the size of duct for which the connector is designed. The present invention also includes methods of use and kits related to the size adjusting device.

### CROSS REFERENCES TO OTHER APPLICATIONS

This application claims the benefit of U.S. provisional application No. 61/135,701, filed on Jul. 23, 2008, which is incorporated herein by reference. It is to be noted that the invention disclosed herein in connection with FIG. 1 through FIG. 16 is also generally disclosed in U.S. nonprovisional patent application Ser. No. 12/075,940, filed by the present inventor on Mar. 14, 2008, and the disclosure of such application is incorporated herein by reference.

### BACKGROUND

There exist in the relevant art apparatus that are used to permanently or removably connect the apparatus to a duct (such as a length of pipe or tubing), in which the apparatus maintains a fluid tight seal between portions of the apparatus and the exterior surface of the duct by means of a compression member being held in place against the exterior surface of the duct. Such apparatus are sometimes referred to as a “compression connector” herein. For example, a pipe fitting, which is also sometimes referred to as a “compression fitting” in the relevant art, may have a tubular rigid or semi-rigid member (such as a ferrule) that is slipped over the exterior surface of a pipe. The pipe is then inserted into the fitting, and the tubular compression member is compressed against the pipe's exterior surface by the interior surfaces of the fitting, forming a fluid-tight seal between the pipe and the fitting. The present invention generally relates to a device that permits a compression connector (such as the pipe fitting) to be used with sizes of ducts (such as the pipe) other than the size of duct originally designed to be used with the compression connector.

As an example for purposes of discussion, a typical type of compression connector (which is by no means exclusive) may use a tubular compression member that is designed to fit tightly against the exterior surface of a duct to which the apparatus is to be connected. Narrowing the example further, the compression connector may be comprised of a coupling that is designed to connect two lengths of pipe together. In this case, the coupling may be comprised of two tubular compression members, each of which is designed to slip over and fit tightly against the exterior surface of each of the pipes near their respective ends. As a result, the compression member is designed to be used, and may only be used, for pipes having a particular diameter. The end of each length of pipe is inserted into an interior space at each end of the coupling. The interior space is generally bounded by a casing sidewall that conforms to the expected size and shape of the pipes for which the coupling is designed. Typically, as described in more detail below, an end cap that fits over the pipe and the compression member is then screwed down onto the casing. The geometry of the interior surfaces of the casing and the end cap is such that as the end cap is screwed onto the casing, the compression member is compressed against the pipe, so that it is forced even tighter against the exterior surface of the pipe. This compression causes a seal to be formed between the coupling and the pipe that is intended to be fluid-tight over the anticipated range of operating pressures (the pressure within the pipes and interior space of the coupling) of the coupling-pipe system.

This type of coupling (as an example of a compression connector) often has several disadvantages. For example, because the compression members of the coupling are designed for use with only a particular size (or narrow range of sizes) of pipe, the coupling can only be used with the particular size (or sizes) of pipe. If the user desires to use the coupling to connect two pipes of different sizes, he or she must often use other types of fittings (such as bushings and adapters) to reduce or enlarge the size of one or both of the pipes so that they can be used with the coupling. Alternatively, the user must procure another coupling of a different size. In either case, the user may incur additional expense in purchasing additional bushings or adapters or a replacement coupling designed to be used with different sizes of pipe. This may also cause the user to make additional trips to the supply warehouse or store, creating additional expense and wasted time. Thus, there is a need for a device that may be used to easily and inexpensively adapt the coupling so that the coupling may be used with more than one size of pipe.

It is to be noted that the device of the present invention is not limited to use with lengths of pipe and tubing alone. It may also be used with other types of ducts, such as conduit, tubing (including medical or food grade tubing), pipeline, hose, channel, vent, a container spout, or other similar ducts or combinations of such ducts, including those having different cross-sectional shapes (such as square or hexagonal). It is also to be noted that the device of the present invention may be used for ducts transporting gases or liquids or both, so that references to a “fluid” herein are intended to refer to both gases and liquids.

### SUMMARY

The present invention is directed to a device and methods of using the device that meet the needs discussed above in the Background section. As described in greater detail below, the present invention, when used for its intended purposes, has many advantages over other devices known in the art, as well as novel features that result in a new device and methods for its use that are not anticipated, rendered obvious, suggested, or even implied by any prior art devices or methods, either alone or in any combination thereof.

In a preferred embodiment, a device is disclosed for use with a compression connector. The compression connector is further comprised of a casing member and at least one compression member. The at least one compression member is adapted to be positioned between the casing member and a first duct, so that a fluid-tight seal is adapted to be formed between the compression connector and the first duct by compression of the at least one compression member between the exterior surface of the first duct and the casing member. In this embodiment, the device is generally comprised of size adjusting means and adjuster sealing means, both of which are described in more detail below. The size adjusting means are adapted for being positioned between a portion of the exterior surface of a second duct and at least a portion of the casing member, as described in more detail below. The second duct generally has a smaller outside cross-sectional perimeter than the first duct. In some embodiments, the size adjusting means are also further comprised of two hollow adjusting compression members adapted to be positioned adjacent to the exterior surface of the second duct, as described in more detail below. The size adjusting means are also adapted to form a fluid-tight seal between the exterior surface of the second duct and the size adjusting means, as described in more detail below. The adjuster sealing means provide a fluid tight seal between the size adjusting means and the casing member, as described in more detail below. In some embodiments, the adjuster sealing means may be further comprised of a washer, gasket or o-ring positioned between the size adjusting means and the casing member. In other embodiments, the adjuster sealing means may be further comprised of an adhesive, adhesive tape, glue, epoxy or any combination thereof positioned between the size adjusting means and the casing member. In some embodiments, the device further comprises the compression connector or the duct or both. The present invention also includes certain kits, such as a kit comprising any combination of components comprising the size adjusting means, a kit comprising the size adjusting means and the casing member, a kit comprising any combination of components comprising the size adjusting means and the casing member, and a kit comprising the adjuster sealing means in combination with any combination of components comprising the size adjusting means or the casing member or both.

In a preferred embodiment, the casing member is further comprised of at least one case cap having a duct opening, a case body having a casing interior space and comprising at least one case body open end adjoining the casing interior space, and case cap connecting means (described in more detail below) for removably or permanently connecting the at least one case cap to the case body at the at least one case body open end. In this preferred embodiment, the case cap connecting means are comprised of threads on a portion of the case body approximately adjacent to the at least one case body open end and corresponding threads on a surface of the at least one case cap, so that the at least one case cap is adapted to be screwed onto the case body at the at least one case body open end. In this embodiment, the size adjusting means are further comprised of a hollow adjusting compression member, a first adjusting member (or case body adjusting member), and a second adjusting member (or case cap adjusting member). The hollow adjusting compression member is comprised of two open ends, each adjoining an interior space of the adjusting compression member. The hollow adjusting compression member is positioned adjacent to the exterior surface of the second duct. The case body adjusting member is positioned between a portion of the case body and a portion of the adjusting compression member. The case cap adjusting member is positioned between a portion of the case cap and a portion of the adjusting compression member. The adjusting compression member is adapted to be compressed between the case body adjusting member, the case cap adjusting member, and the second duct. This compression preferably causes a fluid-tight seal to be formed between the case body adjusting member and the second duct.

In operation, and considering a compression connector in the form of a coupling as an example, the case cap, and then the compression member associated with that case cap, may be removed from one end of the coupling. The case body adjusting member, along with the adjuster sealing means, may then be positioned approximately adjacent to the case body of the coupling. For example, the adjuster sealing means may be comprised of a layer of adhesive covered by a peel-off strip that is positioned around the perimeter of a surface of the case body adjusting member that interfaces with the case body. The peel-off strip may be removed, and the case body adjusting member may then be positioned within the case body so that the adhesive layer abuts against the interior surface of the case body, creating a fluid-tight seal between the case body adjusting member and the case body. The case cap adjusting member, along with adjuster sealing means, may be positioned approximately adjacent to the case cap of the coupling in a manner similar to that described above for the case body adjusting member and the case body. Alternatively, no adjuster sealing means may be used with the case cap adjusting member. The end of the second duct may then be inserted into and through the duct opening of the case cap and the case cap adjusting member. The hollow adjusting compression member may then be slipped over the end of the second duct and positioned on the exterior surface of the second duct near its end. The case cap, with the duct and the hollow adjusting compression member operatively connected thereto, may then be reconnected to the case body so that the hollow adjusting compression member is positioned between the case body adjusting member and the case cap adjusting member. As the case cap is screwed down onto the case body (in embodiments where the case cap connecting means are comprised of threads), the adjusting compression member is compressed between the case body adjusting member, the case cap adjusting member, and the exterior surface of the second duct. This compression is adapted to form a fluid-tight seal between the case body adjusting member and the duct over the range of operating pressures for which the coupling is designed.

In yet another embodiment, the size adjusting means may be further comprised of a hollow first adjusting compression member, a hollow second adjusting compression member, a first adjusting member, and a second adjusting member. The first adjusting compression member and the second adjusting compression member are adapted to be positioned adjacent to one another and around the exterior surface of the duct. The interior spaces of the first adjusting compression member and the second adjusting compression member are each adapted to be positioned adjacent to the exterior surface of the second duct, which is of a smaller size that the first duct. The first adjusting member is positioned between a portion of the casing member and a portion of the first adjusting compression member. The second adjusting member is positioned between a portion of the casing member and a portion of the second adjusting compression member. The first adjusting compression member and the second adjusting compression member are adapted to be compressed between the first adjusting member, the second adjusting member, and the second duct, so that a fluid-tight seal is adapted to be formed between at least the first adjusting member and the second duct.

In still another embodiment, a device is disclosed for use with a compression connector, which is further comprised of a casing member, a first compression member, and a second compression member. The first compression member and the second compression member are adapted to be positioned between the casing member and a first duct, so that a fluid-tight seal is adapted to be formed between at least the first compression connector and the first duct by compression of at least the first compression member between the exterior surface of the first duct and the casing member. In this embodiment, the device is generally comprised of size adjusting means and adjuster sealing means, both of which are described in more detail below.

In an additional embodiment, the casing member of the device is further comprised of at least one case cap having a duct opening, a case body having a casing interior space and comprising at least one case body open end adjoining the casing interior space, and case cap connecting means (described in more detail below) for removably or permanently connecting the at least one case cap to the case body at the at least one case body open end. In this embodiment, the size adjusting means are further comprised of a hollow first adjusting compression member, a hollow second adjusting compression member, a first adjusting member (or case body adjusting member), and a second adjusting member (or case cap adjusting member). The first adjusting compression member and the second adjusting compression member are each adapted to be positioned adjacent to the exterior surface of the second duct. The case body adjusting member is adapted to be positioned between a portion of the case body and a portion of the first adjusting compression member. The case cap adjusting member is adapted to be positioned between a portion of the case cap and a portion of the second adjusting compression member. The first adjusting compression member and the second adjusting compression member are adapted to be compressed between the case body adjusting member, the case cap adjusting member, and the second duct. This compression preferably causes a fluid-tight seal to be formed between at least the case body adjusting member and the second duct.

In yet another embodiment, a device is disclosed for use with a compression connector designed to be connected to a first duct. The compression connector is further comprised of a casing member and at least one compression member similar to that described briefly above. The device is comprised of first size adjusting means, second size adjusting means, and adjuster sealing means, which are all described in more detail below. The first size adjusting means are adapted for forming a fluid-tight seal between the exterior surface of a second duct and the first size adjusting means, wherein the second duct has a smaller outside cross-sectional perimeter than the first duct. The second size adjusting means are adapted to be positioned between a portion of the first size adjusting means and a portion of the casing member. The second size adjusting means are also adapted for forming a fluid-tight seal between at least a portion of the first size adjusting means and a portion of the second size adjusting means. The adjuster sealing means are adapted to provide a fluid tight seal between the second size adjusting means and the casing member.

The present invention therefore meets the needs described above in the Background section. For example, the device of the present invention may be used to connect a compression connector to a second duct having a smaller exterior dimension than a larger first duct for which the compression connector has been designed. Thus, the present invention may save time and expense for users of compression connectors in certain circumstances, as described in more detail above in the Background section.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1 is a partially exploded perspective view of an embodiment of a device of the present invention, as viewed from the side of and above one end of the device.

FIG. 2 is an enlarged plan view of the embodiment of the device illustrated in FIG. 1, as viewed from above one end of the device.

FIG. 3 is an enlarged sectional view of the embodiment of the device illustrated in FIG. 1 and FIG. 2, as taken along the lines 3-3 in FIG. 2.

FIG. 4 is an enlarged perspective view of another embodiment of a case body adjusting member, as viewed from the side of and above the case body adjusting member.

FIG. 5 is an enlarged perspective view of yet another embodiment of a case body adjusting member, as viewed from the side of and above the case body adjusting member.

FIG. 6 is an enlarged perspective view of another embodiment of a case cap adjusting member, as viewed from the side of and above the case body adjusting member.

FIG. 7 is a partially exploded perspective view of another embodiment of a device of the present invention, as viewed from the side of and above one end of the device.

FIG. 8 is a plan view of the embodiment of the device illustrated in FIG. 7, as viewed from above one end of the device.

FIG. 9 is a sectional view of the embodiment of the device illustrated in FIG. 7 and FIG. 8, as taken along the lines 9-9 in FIG. 8.

FIG. 10 is a perspective view of an embodiment of a case body adjusting member, which is a part of the device illustrated in FIG. 7 through FIG. 9, as viewed from the side of and above the body adjuster flange portion of the case body adjusting member.

FIG. 11 is a perspective view of an embodiment of a case cap adjusting member, which is a part of the device illustrated in FIG. 7 through FIG. 9, as viewed from the side of and above the cap adjuster flange portion of the case cap adjusting member.

FIG. 12 is a plan view of another embodiment of size adjusting means, as viewed from above one end of the size adjusting means.

FIG. 13 is a sectional view of the embodiment of the size adjusting means illustrated in FIG. 12, as taken along the lines 13-13 in FIG. 12.

FIG. 14 is a perspective view of an embodiment of an adjusting compression member, which is a part of the size adjusting means illustrated in FIG. 12 and FIG. 13, as viewed from the side of and above one end of the adjusting compression member.

FIG. 15 is a perspective view of an embodiment of a case body adjusting member, which is a part of the size adjusting means illustrated in FIG. 12 and FIG. 13, as viewed from the side of and above the body adjuster flange portion of the case body adjusting member.

FIG. 16 is a perspective view of an embodiment of a case cap adjusting member, which is a part of the size adjusting means illustrated in FIG. 12 and FIG. 13, as viewed from the side of and above the cap adjuster holding portion of the case cap adjusting member.

FIG. 17 is a partially exploded perspective view of yet another embodiment of a device of the present invention, as viewed from the side of and above one end of the device.

FIG. 18 is an enlarged plan view of the embodiment of the device illustrated in FIG. 17, as viewed from above one end of the device.

FIG. 19 is an enlarged sectional view of the embodiment of the device illustrated in FIG. 17 and FIG. 18, as taken along the lines 19-19 in FIG. 18.

FIG. 20 is an enlarged elevation view of an embodiment of an adjusting casing member showing hidden lines in phantom, which is a part of the size adjusting means illustrated in FIG. 17 and FIG. 18.

FIG. 21 is an enlarged perspective view of an embodiment of a case cap adjusting member, which is a part of the size adjusting means illustrated in FIG. 17 and FIG. 19, as viewed from the side of and below the case cap adjusting member.

FIG. 22 is an exploded perspective view of yet another embodiment of a device of the present invention, as viewed from the side of and above one end of the device.

FIG. 23 is a sectional elevation view of (1) an embodiment of a casing adapter member, which is a portion of the size adjusting means illustrated in FIG. 22, and (2) an embodiment of a partial casing member.

FIG. 24 is a partially exploded perspective view of yet another embodiment of a device of the present invention, as viewed from the side of and above one end of the device.

FIG. 25 is an enlarged plan view of the embodiment of the device illustrated in FIG. 24, as viewed from above one end of the device.

FIG. 26 is an enlarged sectional view of the embodiment of the device illustrated in FIG. 24 and FIG. 25, as taken along the lines 26-26 in FIG. 25.

### DETAILED DESCRIPTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications, portions and equivalents, which may be included within the spirit and scope of the invention as defined by the appended claims.

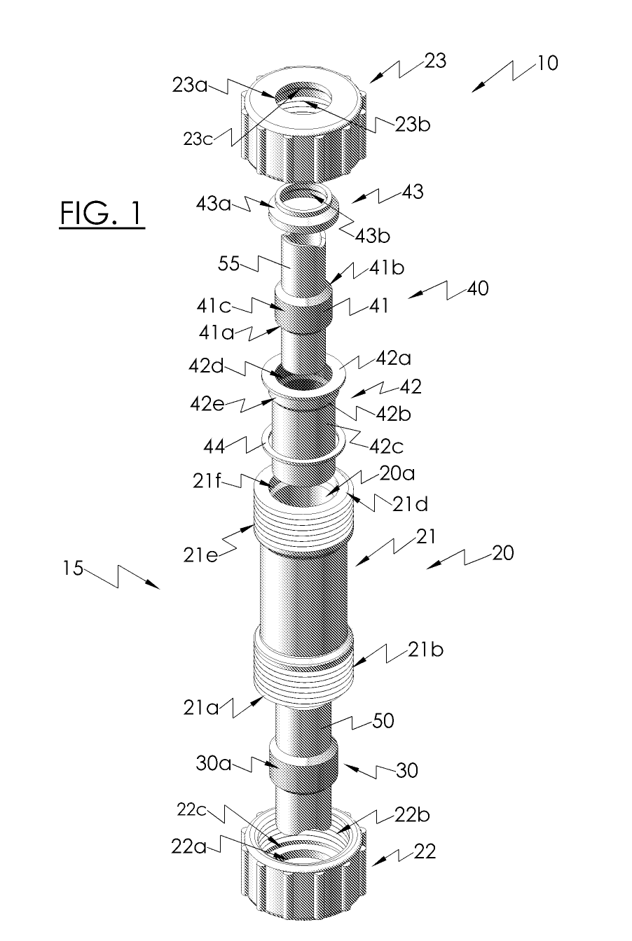

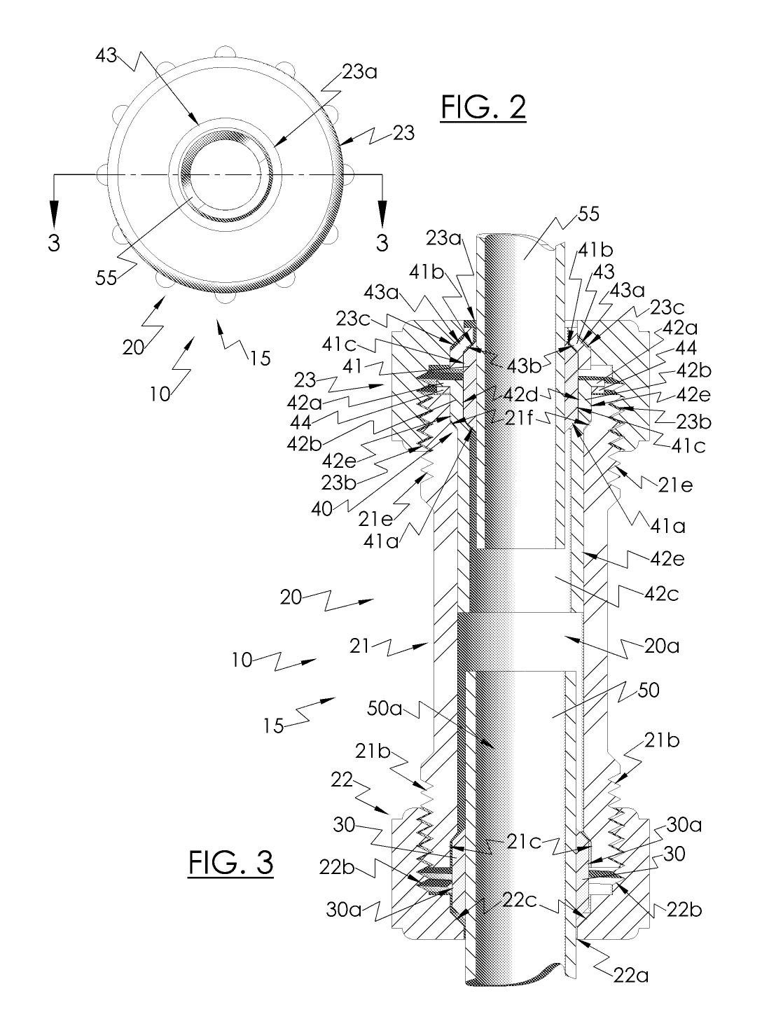

One embodiment of the present invention 10 is illustrated in FIG. 1 through FIG. 3. FIG. 1 presents a partially exploded view of the device 10, FIG. 2 presents a plan view from above one end of the device 10, and FIG. 3 presents a sectional view of the device 10. The device 10 may be used for connecting to one or more ducts (such as pipes 50, 55). In this embodiment, the device 10 is generally comprised of a compression connector 15, size adjusting means, and adjuster sealing means, all of which are described in more detail below. The compression connector 15 is further comprised of a casing member 20 and compression means (compression member 30 in this embodiment), which are described in more detail below. The casing member 20 is further comprised of a case body 21, case caps 22, 23, and case cap connecting means (threads 21b, 21e, 22b, 23b in this embodiment), which are described in more detail below. The size adjusting means 40 are comprised of an adjusting compression member 41, a first adjusting member (case body adjusting member 42 in this embodiment), and a second adjusting member (case cap adjusting member 43 in this embodiment). In some embodiments, as described in more detail below, the present invention may be comprised of the size adjusting means 40 alone, or the size adjusting means 40 (described in more detail below) in combination with the adjuster sealing means (washer 44 in this embodiment, and as described in more detail below), the casing member 20 or the duct (pipe 55) or any of the same. The features of the present invention are now described in more detail.

Although the ducts (pipes 50, 55) illustrated in FIG. 1 through FIG. 3 have a tubular shape, the ducts (pipes 50, 55) may be comprised in whole or in part of conduit, tubing (including medical or food grade tubing), pipeline, duct, hose, channel, vent or other similar objects or combinations of such objects that may be currently known in the relevant art or that may be developed in the relevant art in the future. The ducts (pipes 50, 55) may also have other shapes (such as a cross-sectional shape as an ellipse, triangle, square, rectangle, polygon, or another combination of linear and curved segments) in other embodiments. The ducts (pipes 50, 55) may also be comprised of any materials suitable for constructing conduit, tubing, pipeline, duct, hose, channel, vent or similar objects. Examples include metals (such as steel, steel alloys, aluminum, copper, brass, or other metals or metal alloys), polymers (such as polyvinyl chloride (PVC), polyethylene, acrylonitrile butadiene styrene (ABS), rubber, synthetic rubber (including NEOPRENE), silicon, and other polymers), wood, glass, fiberglass, carbon-based and other composites, or other materials or a combination of such materials. It is also to be noted that the device 10 of the present invention may be used for ducts (pipes 50, 55) transporting gases or liquids or both, so that references to a “fluid” herein are intended to refer to both gases and liquids. In various embodiments, the compression connector 15 may be used to connect to one or more ducts (pipes 50, 55), as described in more detail below.

In the embodiment of the device 10 illustrated in FIG. 1 through FIG. 3, the compression connector 15 is further comprised of a casing member 20 and compression connecting means (comprising compression member 30 in this embodiment), which are described in more detail below. The casing member 20 is further comprised of a hollow, approximately tubular-shaped case body 21 and a case cap 22, 23 positioned at each end of the case body 21. Case cap 23 may have any of the characteristics, features, structure, functions and operation as case cap 22, as described in more detail elsewhere herein. The case cap 22 has a duct opening 22a positioned therein that is of a size and shape adapted to receive the duct (pipe 50). The case cap 22 may be removably or permanently connected to the case body 21 by case cap connecting means, which are described in more detail below. Although the case body 21 is approximately tubular-shaped in the illustrated embodiment, the casing member 20 may have other shapes in other embodiments of the device 10, as long as the casing member 20 has an interior space 20a and a duct opening 22a adjoining the interior space 20a, wherein the duct opening 22a is of a size and shape adapted to receive the duct (pipe 50). In addition, the case body 21 may be comprised of any suitable type of material. For example, the case body 21 may be comprised of metal (such as steel, steel alloys, aluminum, copper, brass, or other metals or metal alloys), polymers (such as PVC, polyethylene, polypropylene, ABS, rubber, and other polymers), wood, fiberglass, carbon-based or other composites, or other materials or a combination of such materials. The case body 21 may be fabricated using any suitable means. For example, a case body 21 constructed of PVC may be formed by injection molding and a case body 21 constructed of brass may be formed by metal injection molding or casting in a mold. In the case of a compression connector 15 designed for use with room temperature domestic potable water and capable of accommodating rigid ducts (pipe 50) in the range of ¾″ to ½″ nominal diameter IPS (iron pipe size), the case body 21 may preferably be tubular in shape and be constructed of PVC.

In the embodiment of the device 10 illustrated in FIG. 1 through FIG. 3, the case cap 22 is approximately cylindrical in shape and may be permanently or removably attached to the open end 21a of the case body 21 adjacent to the case cap 22 by the case cap connecting means, which are described in more detail below. In the illustrated embodiment, which is the preferred embodiment, the case cap connecting means are comprised of threads 21b on the outside surface of the portion of the case body 21 adjacent to the open end 21a of the case body 21 and corresponding threads 22b on the interior surface of the tubular portion of the case cap 22. Thus, the case cap 22 may be placed over the open end 21a of the case body 21, and may then be screwed down onto the case body 21. The case cap 22 may have a different shape in other embodiments, as long as the case cap 22 cooperates with the case body 21 and the compression member 30 to accommodate the operation of the device 10, as described in more detail herein. The case cap 22 may generally be comprised of any materials or combinations of materials that may be used to construct the case body 21, as described in more detail above and illustrated in connection with FIG. 1 through FIG. 3. Although the case cap 22 need not be constructed of the same material as the case body 21, the case cap 22 is preferably constructed of the same material. The case cap 22 may be fabricated using any suitable manufacturing means. For example, a case cap 22 comprised of PVC may be formed by injection molding, and a case cap 22 constructed of brass may be formed by metal injection molding or casting in a mold. In addition, the case cap connecting means may be comprised of means other than the illustrated threads 21b, 22b. For example, other case cap connecting means that may be used to removably connect the case cap 22 to the case body 21 comprise clasps, clamps, clips, pins, screws, nuts, bolts, hinges, other pivoting connectors or other types of connectors, either alone or in conjunction with one another in different combinations. Examples of case cap connecting means that may be used to permanently connect the case cap 22 to the case body 21 include adhesives, epoxies, welding, fusing, nails, or other fasteners or a combination of such means. Preferably, the case cap 22 is generally of the shape illustrated in FIG. 1 through FIG. 3 and has a threaded case cap connecting means.

In the embodiment of the device 10 illustrated in FIG. 1 through FIG. 3, the compression member 30 is tubular in shape and is positioned between the case cap 22 and the case body 21. In other embodiments, the compression member 30 may have another shape, as long as the compression member 30 cooperates with the case cap 22 and the case body 21 to accommodate operation of the device 10, as described in more detail below. For example, the compression member 30 may generally have the shape of any type of ferrule that is used with various types of compression connectors, which are well known in the relevant art or that may be developed in the relevant art in the future. In addition, the compression member 30 may be comprised of any suitable material. For example, as is the case in the illustrated embodiment of the device 10, the compression member 30 may be comprised of rubber, synthetic rubber (including NEOPRENE), elastomers or other flexible, semi-rigid, or rigid polymers, or combinations of such materials, along with a combination that may include a fabric, cloth or mesh constructed of natural materials (such as cotton), polymers, metals or metal alloys, or other materials or a combination of materials. In other embodiments, the compression member 30 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The compression member 30 may be fabricated using any suitable means. For example, a compression member 30 constructed of rubber may be formed by casting in a mold. In the case of a device 10 designed for use with room temperature domestic potable water and capable of accommodating rigid ducts (pipe 11) in the range of ¾″ to ½″ nominal diameter IPS that utilizes a case body 21 constructed of PVC, the compression member 30 may preferably be tubular in shape and be constructed of rubber or synthetic rubber.

In the embodiment of the device 10 illustrated in FIG. 1 through FIG. 3, the compression connecting means are comprised of the compression member 30 and the casing member 20 operating in a manner that utilizes compression between the casing member 20, the compression member 30, and the duct (pipe 50) in a manner adapted to form a fluid-tight seal between the compression connector 15 and the duct (pipe 50). In the illustrated embodiment, a portion of the interior surface 21c of the case body 21 and a portion of the interior surface 22c of the case cap 22 located approximately adjacent to the case body open end 21a are adapted to be positioned adjacent to at least a portion of the exterior surface 30a of the compression member 30. As the case cap 22 is screwed onto the case body 21, the interior surfaces 21c, 22c of the case body 21 and the case cap 22 impinge against the exterior surface 30a of the compression member 30, causing the compression member 30 to be compressed against the exterior surface of the duct (pipe 50). This compression is adapted to form a fluid-tight seal between the compression member 30 and the duct (pipe 50) and between the compression member 30 and the case body 21 within the designed operating pressures of the compression connector 15. The case cap 22 is typically screwed onto the case body 21 to an extent that causes the compression to be adequate to form the desired fluid-tight seal. Thus, when fluid is present within the interior space 20a of the casing member 20 and the interior space 50a of the duct (pipe 50), the fluid-tight connection between the casing member 20, the compression member 30, and the duct (pipe 50) hold the fluid within such interior spaces 20a, 50a of the casing member 20 and the duct (pipe 50), so that the fluid does not escape through the interfaces between the duct (pipe 50), the compression member 30, and the case body 21.

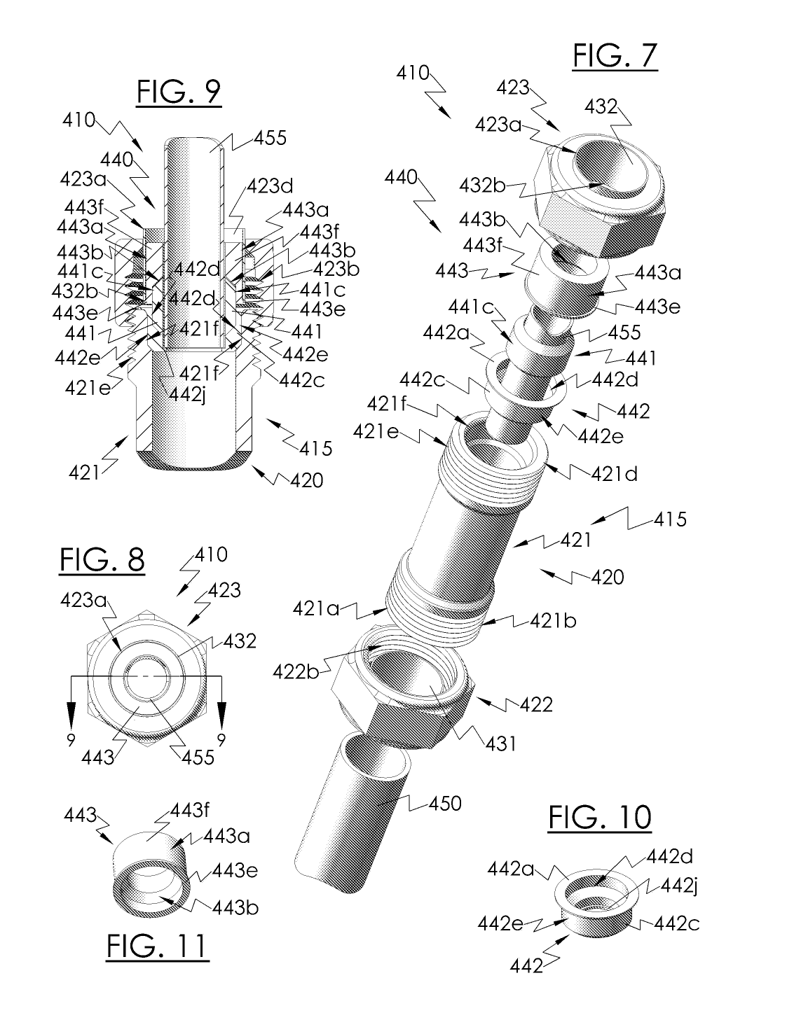

In various embodiments of the device 10, the compression connector 15 may be comprised of almost any form of connector utilizing compression connecting means. Generally, this means may include any connecting means that involves a member being compressed against the exterior surface of a duct to form a fluid-tight seal between the connector and the duct. As an example of another type of such connector, the compression member 30 may be constructed as a part of the case cap 22 or the case body 21, as is described in more detail below and illustrated in connection with FIG. 7 through FIG. 11. In these cases, the fluid-tight seal may be created by compression of only a portion of the compression member 30 against the casing member 20 and the duct (pipe 50) because the portion of the compression member 30 that is attached to the casing member 20 may be sealed by means other than compression. As another example, the compression connector 15 may utilize any of the compression connecting means utilized by the devices 610, 710, as described in more detail below and illustrated in connection with FIG. 17 through FIG. 23. In the embodiment of the device 10 illustrated in FIG. 1 through FIG. 3, the compression connector 15 is generally in the configuration of a coupling, so that it can accommodate connection to two ducts (such as pipes 50, 55) simultaneously. In other embodiments, the compression connector 15 may be incorporated in a variety of ways in any standard types of fittings, which may be fabricated as a part of or be attached to the compression connector 15. For example, the compression connector 15 may be fabricated as a portion of a 45 degree or 90 degree elbow, in which compression connecting means may be located at either or both openings of the elbow or in combination with any other connecting means (such as a male iron pipe (MIP) or female iron pipe (FIP) connection). As yet another example, the compression connector 15 may be fabricated as a portion of a tee, in which compression connecting means may be located at one or more openings of the tee and in combination with any other connecting means (such as a male iron pipe (MIP) or female iron pipe (FIP) connection), each being positioned in various openings of the tee that receive ducts (such as pipes 50, 55). Similarly, the compression connector 15 may be formed to have substantially the same geometry and configuration of any type of fitting or connector that may be used to connect to ducts, with compression connecting means positioned in openings designed to receive ducts in a variety of combinations in conjunction with any other connecting means. Thus, in various embodiments, the compression connector 15 may be used to connect to one or more ducts utilizing compression connecting means or other means or a combination of compression connecting means and such other means.

In the embodiment of the compression connector 15 illustrated in FIG. 1 through FIG. 3, the other open end 21d of the case body 21 and the case cap 23 that is adapted to be connected to it may have substantially the same structure, features, characteristics, functions and operation as the open end 21a of the case body 21 and the case cap 22, as described in more detail above and illustrated in connection with FIG. 1 through FIG. 3. As a result, the illustrated case cap 23 is approximately cylindrical in shape and may be permanently or removably attached to the open end 21d of the case body 21 adjacent to the case cap 23 by the case cap connecting means, which are comprised of threads 21e on the outside surface of the portion of the case body 21 adjacent to the open end 21d of the case body 21 and corresponding threads 23b on the interior surface of the tubular portion of the case cap 23. Thus, the case cap 23 may be placed over the open end 21d of the case body 21, and may then be screwed down onto the case body 21. A compression member (not illustrated, but substantially the same as compression member 30 described in more detail above and illustrated in connection with FIG. 1 through FIG. 3) may be used to connect ducts (such as pipe 50) that are of the appropriate size to the compression connector 15.

The compression connector 15, however, is generally adapted to be connected to one size of duct (pipe 50). Thus, if the user of the compression connector 15 attempts to connect the compression connector 15 to a second duct (such as pipe 55) that is smaller than the design size of duct (pipe 50), the compression member 30 is generally too large to compress against the exterior surface of the second duct (such as pipe 55) in a manner that will form a fluid-tight seal between the second duct (such as pipe 55) and the casing member 20. In such cases, the size adjusting means 40 and the adjuster sealing means (washer 44 in this embodiment, as described in more detail below) of the present invention may be used to connect the second duct (pipe 55) to the compression connector 15. Generally, the size adjusting means 40 are adapted to be positioned between a portion of the exterior surface of the second duct (pipe 55) and at least a portion of the casing member 20. The size adjusting means 40 are also adapted to form a fluid-tight seal between the exterior surface of the second duct (pipe 55) and the size adjusting means 40 in those cases where the second duct (pipe 55) has a smaller outside cross-sectional perimeter than the first duct (pipe 50), which first duct (pipe 50) is of the size and shape designed for use with the compression connector 15. In the illustrated embodiment, the size adjusting means 40 are comprised of a hollow adjusting compression member 41, a first adjusting member (case body adjusting member 42 in this embodiment), and a second adjusting member (case cap adjusting member 43 in this embodiment).

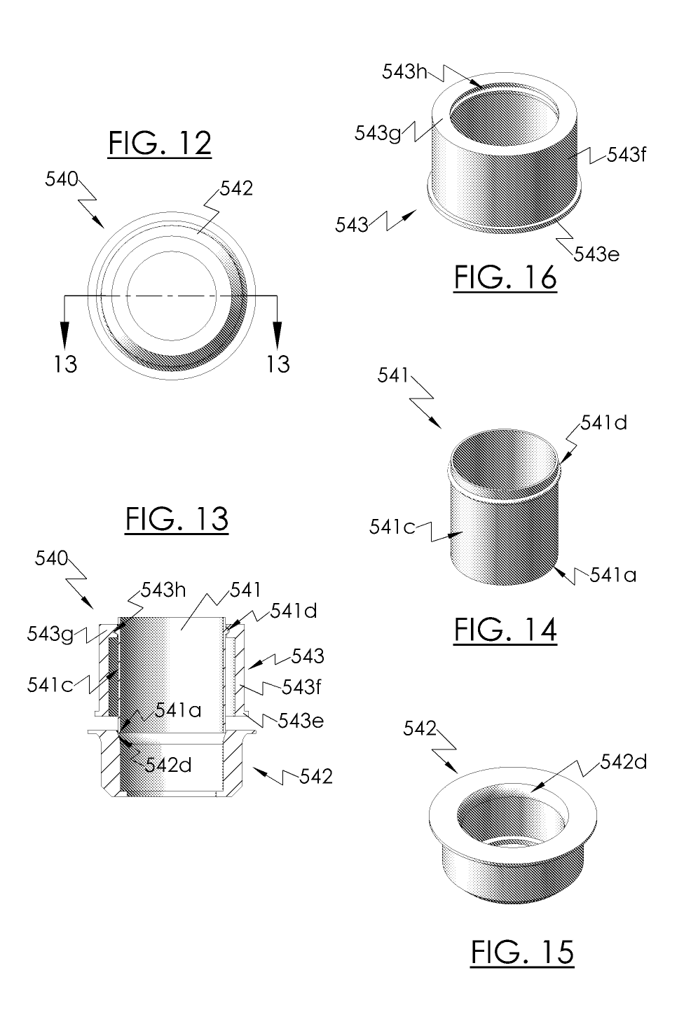

The hollow adjusting compression member 41 may generally have any of the same structures, features, characteristics, functions, and operation as the compression member 30 described in more detail above and illustrated in connection with FIG. 1 through FIG. 3, except that the size and shape of the adjusting compression member 41 is such that it is adapted to be positioned adjacent to the exterior surface of the second duct (pipe 55), and to be compressed between the first adjusting member (case body adjusting member 42 in this embodiment), the second adjusting member (case cap adjusting member 43 in this embodiment), and the second duct (pipe 55), so that a fluid-tight seal is adapted to be formed between the first adjusting member (case body adjusting member 42 in this embodiment) and the second duct (pipe 55). In the illustrated embodiment, the adjusting compression member 41 is approximately tubular in shape and is comprised of two open ends 41a, 41b, each adjoining an interior space of the adjusting compression member 41. In other embodiments, the adjusting compression member 41 may have a different shape and configuration, such as any shape that may be used for the compression member 30, as described in more detail above and illustrated in connection with FIG. 1 through FIG. 3. As another example, the adjusting compression member 41 may have a different tubular shape with a ridge portion on its outside surface as is the case for the adjusting compression member 541 described in more detail below and illustrated in connection with FIG. 12 and FIG. 14. The adjusting compression member 41 may generally be comprised of any material or materials that may comprise the compression member 30, as described in more detail above and illustrated in connection with FIG. 1 through FIG. 3. The adjusting compression member 41 may also be fabricated using any means that may be used to fabricate the compression member 30, as described in more detail above and illustrated in connection with FIG. 1 through FIG. 3. In the case of a compression connector 15 having a casing member 20, case body adjusting member 42, and case cap adjusting member 43 constructed of PVC and designed for use with room temperature domestic potable water and capable of accommodating rigid ducts (pipe 55) in the range of ¾″ to ½″ nominal diameter IPS, the adjusting compression member 41 may preferably be tubular in shape and be constructed of rubber or synthetic rubber.

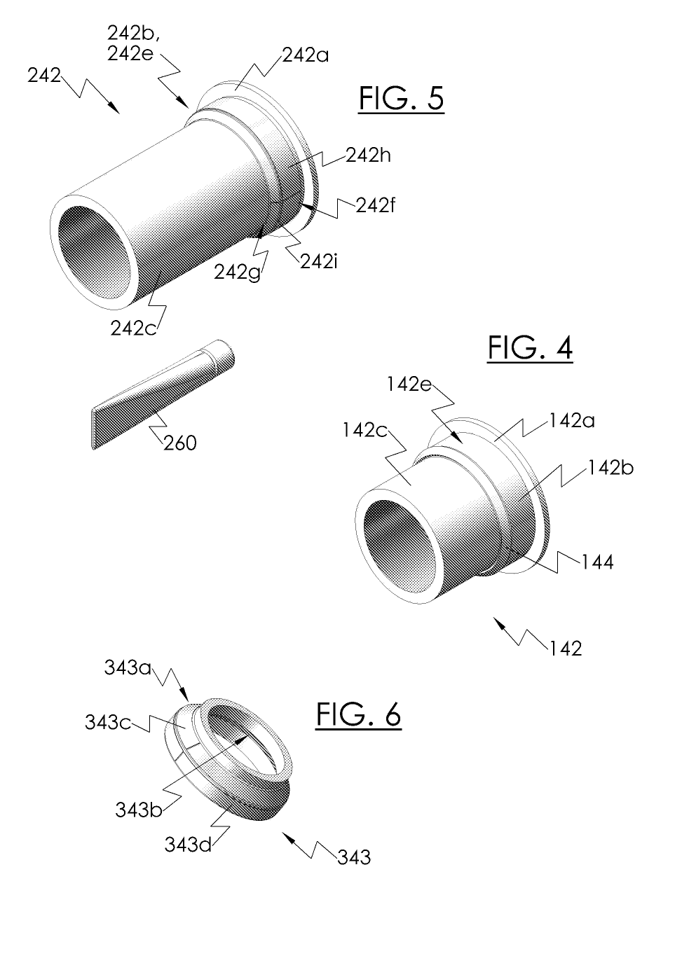

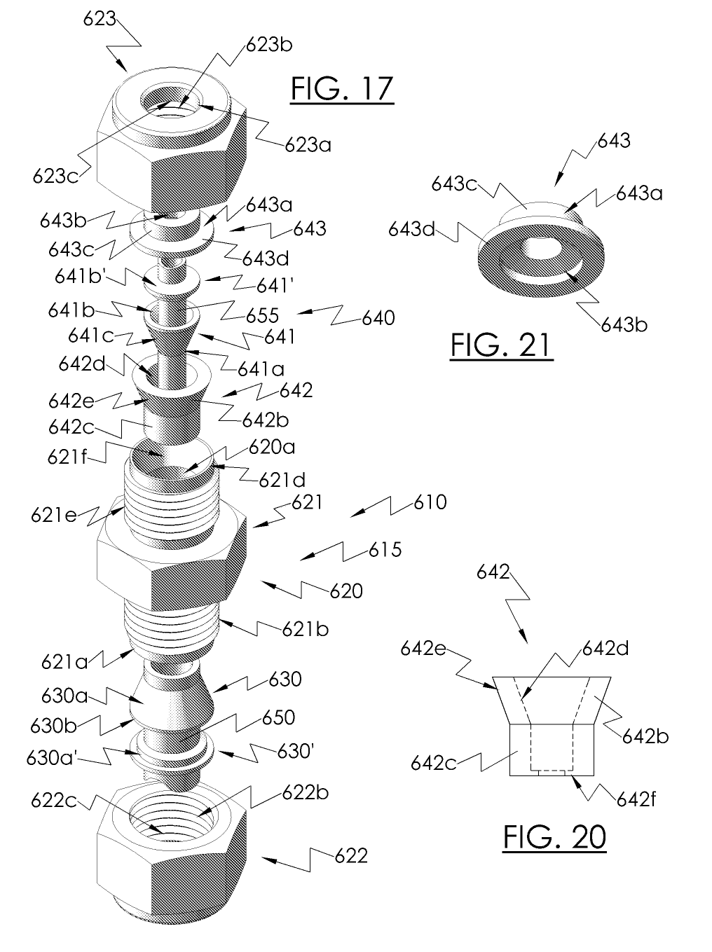

In the embodiment of the device 10 illustrated in FIG. 1 through FIG. 3, the first adjusting member (case body adjusting member 42 in this embodiment) is positioned between a portion of the casing member 20 and a portion of the adjusting compression member 41 at one open end 41a of the adjusting compression member 41. In the illustrated embodiment, the case body adjusting member 42 is comprised of an adjuster flange portion 42a, an adjuster flange transition portion 42b that extends from the adjuster flange portion 42a, and an adjuster sheath portion 42c that extends from the adjuster flange transition portion 42b. The case body adjusting member 42 is also comprised of an inside surface 42d and an outside surface 42e. In the illustrated embodiment, the case body adjusting member 42 is positioned approximately within the case body open end 21d, which is also approximately adjacent to the case body 21. By “approximately within the case body open end 21d” and “approximately adjacent to the case body 21,” it is meant that the case body adjusting member 42 is adapted to be positioned within the case body open end 21d with the adjuster flange portion 42a or the adjuster flange transitional portion 42b (or both) adjacent to the open end 21d and the adjoining interior surface 21f of the case body 21, respectively, but that other members, such as adjuster sealing means (which are described in more detail below, but such as washer 44) may be positioned between the adjuster flange portion 42a and the adjuster flange transition portion 42b, on the one hand, and the open end 21d and interior surface 21f of the case body 21, on the other hand. Also in this embodiment, the adjuster flange transition portion 42b and the adjuster sheath portion 42c extend into the interior space 20a of the casing member 20. The adjuster flange portion 42a, the adjuster flange transition portion 42b, and the adjuster sheath portion 42c may have another positioning and configuration in other embodiments, as may be necessary for the adjusting case body member 42 to be operatively connected to the casing member 20 and to operatively engage the remaining components of the size adjusting means 40. For example, the adjusting case body member 42 may have a different length of adjuster sheath portion 142c (shorter in this embodiment), as is illustrated in the case body adjusting member 142 illustrated in FIG. 4. As another example, the adjusting case body member 42 may have a different shape, as described in more detail below and illustrated in connection with FIG. 7 through FIG. 26. In the illustrated embodiment, the outside surface 42e of the adjusting case body member 42 generally has a size and shape so that it fits adjacent to the portion of the interior surface 21f of the case body 21 that is adjacent to the open end 21d of the case body 21. In other embodiments, adjuster sealing means may be positioned between the exterior surface 42e of the case body adjusting member 42 and the interior surface 21f of the case body 21, as described in more detail below. Also in the illustrated embodiment, the outside surface 42e of the adjuster flange portion 42a, the adjuster flange transition portion 42b, and the adjuster sheath portion 42c is positioned approximately adjacent to the open end 21d and interior surface 21f, respectively, of the case body 21, but this need not be the case in all embodiments. In the illustrated embodiment, the inside surface 42d of the adjusting case body member 42 generally has a size and shape so that it fits adjacent to a portion of the exterior surface 41c of the adjusting compression member 41 that is adjacent to the open end 41a of the adjusting compression member 41. The adjusting case body member 42 may be comprised of any suitable type of material. For example, the adjusting case body member 42 may be comprised of metal (such as steel, steel alloys, aluminum, copper, brass, or other metals or metal alloys), polymers (such as PVC, polyethylene, polypropylene, ABS, rubber, and other polymers), wood, fiberglass, carbon-based or other composites, or other materials or a combination of such materials. The adjusting case body member 42 may be fabricated using any suitable means. For example, an adjusting case body member 42 constructed of PVC may be formed by injection molding and an adjusting case body member 42 constructed of brass may be formed by metal injection molding or casting in a mold. In the case of a compression connector 15 having a casing member 20 constructed of PVC and designed for use with room temperature domestic potable water and capable of accommodating rigid ducts (pipe 55) in the range of ¾″ to ½″ nominal diameter IPS, the adjusting case body member 42 may preferably have the illustrated shape and be constructed of PVC.

In the embodiment of the device 10 illustrated in FIG. 1 through FIG. 3, the second adjusting member (case cap adjusting member 43 in this embodiment) is positioned between a portion of the casing member 20 and a portion of the adjusting compression member 41 at the other open end 41b of the adjusting compression member 41. In the illustrated embodiment, the case cap adjusting member 43 has a lofted, approximately annular shape and is comprised of an outside surface 43a and an inside surface 43b. In the illustrated embodiment, the case cap adjusting member 43 is positioned approximately within the duct opening 23a of the case cap 23, which is also approximately adjacent to the case cap 23. By “approximately within the duct opening 23a” and “approximately adjacent to the case cap 23,” it is meant that the case cap adjusting member 43 is adapted to be positioned within the duct opening 23a with the exterior surface 43a of the case cap adjusting member 43 positioned adjacent to the duct opening 23a of the case cap 23, but that there may be a gap between such exterior surface 43a and the duct opening 23a or other members, such as adjuster sealing means (which are described in more detail below) may be positioned between the case cap adjusting member 43 and the duct opening 23a. It is to be noted that the case cap adjusting member 43 may have another positioning and configuration in other embodiments, as may be necessary for the case cap adjusting member 43 to be operatively connected to the case cap 23 and to operatively engage the remaining components of the size adjusting means 40. For example, the case cap adjusting member 43 may have a different shape, as described in more detail below and illustrated in connection with FIG. 7 through FIG. 26. In the illustrated embodiment, the outside surface 43a of the case cap adjusting member 43 generally has a size and shape so that it fits adjacent to the portion of the interior surface 23c of the case cap 23 that is adjacent to the duct opening 23a of the case cap 23. In other embodiments, adjuster sealing means may be positioned between the exterior surface 43a of the case cap adjusting member 43 and the interior surface 23c of the case cap 23, as described in more detail below. In the illustrated embodiment, the inside surface 43b of the case cap adjusting member 43 generally has a size and shape so that it fits adjacent to a portion of the exterior surface 41c of the adjusting compression member 41 that is adjacent to the other open end 41b of the adjusting compression member 41. The case cap adjusting member 43 may be comprised of any suitable type of material or materials that may comprise the case body adjusting member 42, as described in more detail above and illustrated in connection with FIG. 1 through FIG. 3. Although the case body adjusting member 42 and the case cap adjusting member 43 need not be comprised of the same material, they are preferably comprised of the same material or materials. The case cap adjusting member 43 may be fabricated using any suitable means. For example, a case cap adjusting member 43 constructed of PVC may be formed by injection molding and a case cap adjusting member 43 constructed of brass may be formed by metal injection molding or casting in a mold. In the case of a compression connector 15 having a casing member 20 constructed of PVC and designed for use with room temperature domestic potable water and capable of accommodating rigid ducts (pipe 55) in the range of ¾″ to ½″ nominal diameter IPS, the case cap adjusting member 43 may preferably have the illustrated shape and be constructed of PVC.

In the embodiment of the device 10 illustrated in FIG. 1 through FIG. 3, the device 10 is further comprised of adjuster sealing means for providing a fluid tight seal between the size adjusting means 40 and the casing member 20. In the illustrated embodiment, the adjuster sealing means is comprised of a washer 44 that is positioned between the adjuster flange portion 42a and the open end 21d of the case body 21. As the case cap 23 is screwed onto the case body 21, the washer 44 is compressed between the adjuster flange portion 42a and the open end 21d of the case body 21 so that a fluid-tight seal is adapted to be formed between the case body adjusting member 42 and the case body 21 at their interface with the washer 44. In other embodiments, the adjuster sealing means may also be comprised of a washer 44 that is positioned in a different location relative to the adjusting member 42 or the casing member 20 or both. For example, as illustrated in FIG. 4, the washer 144 may be positioned adjacent to a portion of the adjuster flange transition portion 142b, rather than adjacent to the adjuster flange portion 142a. In other embodiments, the adjuster sealing means may comprise more than one washer 44, 144. For example, in some embodiments, the device 10 may comprise both a washer 44 and a washer 144, as illustrated in FIG. 1 through FIG. 4. In embodiments where the adjuster sealing means are comprised of one or more washers 44, 144, the washer or washers 44, 144 may be comprised of any suitable material. Examples of such materials include rubber, synthetic rubber (including NEOPRENE), other elastomers or polymers (such as silicon, polyethylene, and other polymers), or other materials or a combination of such materials, along with a combination that may including cloth, fabric or other materials. In some embodiments, especially devices 10 that operate under high pressures, the washers 44, 144 may be comprised of metal (such as copper, brass, or other metals or metal alloys), fiberglass, carbon-based or other composites, or other materials or a combination of such materials. It is to be noted that the washers 44, 144 may have a different shape than that illustrated in FIG. 1 through FIG. 4. For example, the washers 44, 144 may be in the form of a gasket or an o-ring, or have a shape characterized by any combination of linear segments or curved segments or both when viewed from almost any angle.

In other embodiments, the adjuster sealing means may take a form other than a washer 44, 144, gasket, o-ring or similar member. For example, and referring to the device 10 illustrated in FIG. 1 through FIG. 3 as an example, the adjuster sealing means may form the fluid-tight seal by compression forcing all or a portion of the surface 42e of the case body adjusting member 42 tightly against all or a portion of the adjoining surfaces 21f of the case body 21. As another example, as illustrated in FIG. 5, the case body adjusting member 242 may be further comprised of one or more layers of adhesive 242f, 242g positioned on the outside surface 242e of the case body adjusting member 242. Thus, an adhesive layer 242f may be positioned on the exterior surface of 242e of the adjuster flange transition portion 242b approximately adjacent to the adjuster flange portion 242a, and another adhesive layer 242g may be positioned on the exterior surface of 242e of the adjuster flange transition portion 242b approximately adjacent to the adjuster sheath portion 242c. In various embodiments, the case body adjusting member 242 may be comprised of one or more of such adhesive layers 242f, 242g positioned on various locations on the outside surface 242e of the case body adjusting member 242. The adhesive layers 242f, 242g may be comprised of any suitable type of material, such as adhesive, glue, epoxy or other joining compound or a combination of such means that is stored in a container or other receptacle, such as tube 260 illustrated in FIG. 5. Generally, the user of the case body adjusting member 242 may remove the lid from the container 260, place some of the adhesive from the container 260 on all or a portion of the outside surface 242e of the case body adjusting member 242 or on a portion of the interior surface of the casing member (not illustrated) where contact with the case body adjusting member 242 is anticipated or on a combination of such surfaces. The case body adjusting member 242 may then be positioned approximately within the case body in the manner described in more detail above and illustrated in connection with FIG. 1 through FIG. 3. As the case body adjusting member 242 is inserted, the adhesive is spread over the adjacent surfaces so that a film or layer 242f, 242g of adhesive is created between the case body adjusting member 242 and the case body. The adhesive film 242f, 242g may provide for a relatively permanent attachment of the case body adjusting member 242 and the case body, so that the case body adjusting member 242 is not easily removed from the case body. An example of this type of adhesive is Cyanoacrylate (methyl-2-cyanoacrylate), which may be typically sold under the trademark SUPERGLUE. Alternatively, the adhesive film 242f, 242g may provide for non-permanent attachment of the case body adjusting member 242 to the case body, so that the case body adjusting member 242 may be relatively easily removed from the case body after use of the device is completed. An example is an adhesive similar to rubber cement made from a polymer (such as latex) mixed in a solvent such as acetone, hexane, heptane or benzene to keep the polymer fluid prior to use.

In addition, as is illustrated in FIG. 5, the adjuster sealing means may be comprised of one or more adhesive layers 242f, 242g and a peel-off strip 242h, 242i, respectively, positioned over the adhesive layers 242f, 242g. The adhesive layers 242f, 242g may be comprised of any suitable adhesive and the peel-off strips 242h, 242i are positioned over the adhesive layers 242f, 242g to protect them and keep them from setting or drying out during storage prior to use of the device. Preferably, the adhesive layers 242f, 242g are comprised of an adhesive material that is resistant to the fluid contained in the duct (not illustrated) and the peel-off strips 242f, 242g are comprised of paper or a polymer material. For example, the adhesive layers 242f, 242g and peel-off strips 242f, 242g may be comprised of double coated urethane, vinyl or polyethylene adhesive tapes with release liners, such as those manufactured by the 3M Company. In operation, and prior to positioning the case body adjusting member 242 approximately within the open end of the case body (as described in more detail above and illustrated in connection with FIG. 1 through FIG. 3), the user of the case body adjusting member 242 pulls on the peel-off strips 242h, 242i until the peel-off strips 242f, 242g are removed from the case body adjusting member 242, exposing the adhesive layers 242f, 242g. The case body adjusting member 242 is then positioned approximately within the open end of the case body, as described above and illustrated in connection with FIG. 1 through FIG. 3. The adhesive in the adhesive layers 242f, 242g adheres to the outside surface 242e of the case body adjusting member 242, as well as the adjoining surfaces of the case body, providing a fluid-tight seal between the case body adjusting member 242 and the case body when the adhesive in the adhesive layers 242f, 242g is allowed to set. It is to be noted that in other embodiments of the present invention, adhesive layers 242f, 242g with peel-off strips may be positioned on an interior surface of the case body either with or without an adhesive layer 242f, 242g being present on the case body adjusting member 242. In other embodiments, an adhesive layer 242f, 242g may be used in conjunction with other adjuster sealing means, such as washers 44, 144 described in more detail above and illustrated in connection with FIG. 1 through FIG. 4.

As is illustrated in FIG. 6, adjuster sealing means may also be used in conjunction with the case cap adjusting member 343. For example, the case cap adjusting member 343 may further comprise one or more adhesive layers 343c, 343d that are positioned on the outside surface 343a of the case cap adjusting member 343. The adhesive layers 343c, 343d may be comprised of substantially any of the structures, features, characteristics, functions and operation as the adhesive layers 242f, 242g comprising the case body adjusting member 242 described in more detail above and illustrated in connection with FIG. 5. Thus, as is illustrated in FIG. 6, the adhesive layers 343c, 343d are covered with a peel-off strip. In operation, the peel-off strip is removed, exposing the adhesive layers 343c, 343d, and the case cap adjusting member 343 is then positioned approximately within the duct opening of the case cap (not illustrated) in the manner described in more detail above and illustrated in connection with FIG. 1 through FIG. 3. In other embodiments, the adjuster sealing means utilized with the case cap adjusting member 343 may take another form, such as the washers 44, 144, gaskets, o-rings and other means described in more detail above and illustrated in connection with FIG. 1 through FIG. 3, or a combination of such means with or without adhesive layers 343c, 343d. It is to be noted that adjuster sealing means (such as adhesive layers 343c, 343d) may not be utilized with every embodiment of the case cap adjusting member 343 because it is not always necessary to form a fluid-tight seal between the case cap adjusting member 343 and the case cap.

Referring to the device 10 illustrated in FIG. 1 through FIG. 3 as an example, the present invention also includes methods of using the size adjusting means 40 and the adjuster sealing means (washer 44). For example, the method may include positioning the cap adjusting member 43 approximately adjacent to the casing member 20 (approximately within the duct opening 23a of the case cap 23), positioning the case body adjusting member 42 approximately adjacent to the casing member 20 (approximately within the open end 21d of the case body 21), and positioning the adjusting compression member 41 adjacent to the second duct (pipe 55). These may be performed in any order. The method then comprises, in any order, positioning the case cap adjusting member 43 adjacent to the adjusting compression member 41 and positioning the case body adjusting member 42 adjacent to the adjusting compression member 41. The method further comprises compressing the adjusting compression member 41 between the case cap adjusting member 43, the case body adjusting member 42, and the second duct (pipe 55). This compression is adapted to form a fluid tight seal between the second duct (pipe 55) and the case body adjusting member 42.

Referring to the device 10 illustrated in FIG. 1 through FIG. 3 as an example, it is to be noted that the size adjusting means 40 may have different shapes and configurations in other embodiments as may be necessary to operatively connect the size adjusting means 40 to the casing member 20 and the duct (pipe 55). Thus, the size and shape of the size adjusting means 40 may take almost any size, shape and configuration in order to accommodate different sizes and shapes of compression connectors 15, so that the size adjusting means 40 are not limited to the size, shape and configuration illustrated in FIG. 1 through FIG. 3. Examples are represented by devices 410, 610, 710, 810, as described in more detail below and illustrated in connection with FIG. 7 through FIG. 26. In the embodiment of the device 410 illustrated in FIG. 7 through FIG. 11, FIG. 7 presents a partially exploded view of the device 410, FIG. 8 presents a plan view from above one end of the device 410, FIG. 9 presents a sectional view of the device 410, and FIG. 10 and FIG. 11 present perspective views of the first adjusting member (case body adjusting member 442) and the second adjusting member (case cap adjusting member 443), respectively, comprising the device 410. The device 410 may be used for connecting to one or more ducts (such as pipes 450, 455). In this embodiment, the device 410 is generally comprised of a compression connector 415, size adjusting means, and adjuster sealing means, all of which are described in more detail below. The compression connector 415 is further comprised of a casing member 420 and compression means (compression members 431, 432 in this embodiment), which are described in more detail below. The casing member 420 is further comprised of a case body 421, case caps 422, 423, and case cap connecting means (threads 421b, 421e, 422b, 423b in this embodiment), which are described in more detail below. Except as described below, the casing member 420 may have substantially the same structure, features, characteristics, functions, and operation as any of the embodiments of the casing member 20 of the compression connector 15 described in more detail above and illustrated in connection with FIG. 1 through FIG. 3. In addition, and except as described below, the compression members 431, 432 may also have substantially the same structure, features, characteristics, functions, and operation as any of the embodiments of the compression member 30 of the compression connector 15 described in more detail above and illustrated in connection with FIG. 1 through FIG. 3. In the embodiment of the compression connector 415 illustrated in FIG. 7 through FIG. 11, however, the compression members 431, 432 are operatively connected to the case caps 422, 423, respectively, so that they may not generally be removed from the case caps 422, 423, respectively. In this embodiment, and considering compression member 431 as an example, as the case cap 422 is screwed onto the case body 421, the compression member 431 impinges upon a portion of the interior surface (not illustrated, but substantially the same as the interior surface 421f) of the case body 421 adjacent to the open end 421a of the case body 421. As the case cap 422 is further screwed down onto the case body 421, the interior surface of the compression member 431 is compressed against the exterior surface of the duct (pipe 450), forming a fluid-tight seal between the compression connector 415 and the duct (pipe 450). Thus, in the embodiment of the device 410 illustrated in FIG. 7 through FIG. 11, the compression connecting means are comprised of the compression member 431, as it is operatively connected to the case cap 422, and the casing member 420 operating in a manner that utilizes compression between the casing member 420, the compression member 431, and the duct (pipe 450) in a manner adapted to form a fluid-tight seal between the compression connector 415 and the duct (pipe 450).

The compression connector 415, however, is also generally adapted to be connected to one size of duct (pipe 450). The size adjusting means 440 and the adjuster sealing means (compression of the first adjusting member (case body adjusting member 442) against the case body 421 in this embodiment, as described in more detail below) of the present invention may be used to connect a second duct (pipe 455) to the compression connector 415. Generally, the size adjusting means 440 are adapted to be positioned between a portion of the exterior surface of the second duct (pipe 455) and all or a portion of the casing member 420. The size adjusting means 440 are also adapted to form a fluid-tight seal between the exterior surface of the second duct (pipe 455) and the size adjusting means 440 in those cases where the second duct (pipe 455) has a smaller outside cross-sectional perimeter than the first duct (pipe 450), which first duct (pipe 450) is of the size and shape designed for use with the compression connector 415. In the illustrated embodiment, the size adjusting means 440 are comprised of a hollow adjusting compression member 441, a first adjusting member (case body adjusting member 442 in this embodiment), and a second adjusting member (case cap adjusting member 443 in this embodiment).

In this embodiment, the hollow adjusting compression member 441 may generally have any of the same structures, features, characteristics, functions, and operation as the adjusting compression member 41 described in more detail above and illustrated in connection with FIG. 1 through FIG. 3, except that the size and shape of the adjusting compression member 441 is such that it is adapted to be positioned adjacent to the exterior surface of the second duct (pipe 455), and to be compressed between the first adjusting member (case body adjusting member 442 in this embodiment), the second adjusting member (case cap adjusting member 443 in this embodiment), and the second duct (pipe 455), so that a fluid-tight seal is adapted to be formed between the first adjusting member (case body adjusting member 442 in this embodiment) and the second duct (pipe 455). In the illustrated embodiment, the adjusting compression member 441 has approximately the same shape as the adjusting compression member 41 described in more detail above and illustrated in connection with FIG. 1 through FIG. 3. In other embodiments, the adjusting compression member 441 may have a different shape and configuration. For example, the adjusting compression member 441 may have a different tubular shape with a ridge portion on its outside surface as is the case for the adjusting compression member 541 described in more detail below and illustrated in connection with FIG. 12 and FIG. 14.

In the embodiment of the device 410 illustrated in FIG. 7 through FIG. 11, the first adjusting member (case body adjusting member 442 in this embodiment) is positioned between a portion of the casing member 420 and a portion of the adjusting compression member 441 at one open end of the adjusting compression member 441. The first adjusting member (case body adjusting member 442) may have substantially the same structure, features, characteristics, functions, and operation as any of the embodiments of the first adjusting member (case body adjusting member 42) of the device 10 described in more detail above and illustrated in connection with FIG. 1 through FIG. 3. In the illustrated embodiment, the case body adjusting member 442 is comprised of a body adjuster flange portion 442a, a body adjuster sheath portion 442c that extends from the body adjuster flange portion 442a, and a body adjuster end portion 442j that is positioned at the distal end of the body adjuster sheath portion 442c. The case body adjusting member 442 is also comprised of an inside surface 442d and an outside surface 442e. In the illustrated embodiment, the case body adjusting member 442 is positioned approximately within the case body open end 421d, which is also approximately adjacent to the case body 421. By “approximately within the case body open end 421d” and “approximately adjacent to the case body 421,” it is meant that the case body adjusting member 442 is adapted to be positioned within the case body open end 421d with the body adjuster flange portion 442a or the body adjuster sheath portion 442c (or both) adjacent to the open end 421d and the adjoining interior surface 421f of the case body 421, respectively, but that other members, such as adjuster sealing means (which are described in more detail below) may be positioned between the body adjuster flange portion 442a and the body adjuster sheath portion 442c, on the one hand, and the open end 421d and interior surface 421f of the case body 421, on the other hand. The body adjuster end portion 442j is adapted to stop the travel of the duct (pipe 455) into the case body 421. The body adjuster flange portion 442a, the body adjuster sheath portion 442c, and the body adjuster end portion 42c may have another positioning and configuration in other embodiments, as may be necessary for the adjusting case body member 442 to be operatively connected to the casing member 420 and to operatively engage the remaining components of the size adjusting means 440. In the illustrated embodiment, the outside surface 442e of the adjusting case body member 442 generally has a size and shape so that it fits adjacent to the portion of the interior surface 421f of the case body 421 that is adjacent to the open end 421d of the case body 421. In other embodiments, adjuster sealing means may be positioned between the exterior surface 442e of the case body adjusting member 442 and the interior surface 421f of the case body 421, as described in more detail below. Also in the illustrated embodiment, the outside surface 442e of the adjuster sheath portion 442c is positioned approximately adjacent to the interior surface 421f of the case body 421, but this need not be the case in all embodiments. In the illustrated embodiment, the inside surface 442d of the adjusting case body member 442 generally has a size and shape so that it fits adjacent to a portion of the exterior surface 441c of the adjusting compression member 441 that is adjacent to the open end of the adjusting compression member 441.

In the embodiment of the device 410 illustrated in FIG. 7 through FIG. 11, the second adjusting member (case cap adjusting member 443 in this embodiment) is positioned between a portion of the casing member 420 and a portion of the adjusting compression member 441 at the other open end of the adjusting compression member 441. The second adjusting member (case cap adjusting member 443) may have substantially the same structure, features, characteristics, functions, and operation as any of the embodiments of the first adjusting member (case cap adjusting member 42) of the device 10 described in more detail above and illustrated in connection with FIG. 1 through FIG. 3. In the illustrated embodiment, the case cap adjusting member 443 is comprised of a cap adjuster flange portion 443e and a cap adjuster sheath portion 443f that extends from the cap adjuster flange portion 443e. The case cap adjusting member 443 is also comprised of an outside surface 443a and an inside surface 443b. In the illustrated embodiment, the case cap adjusting member 443 is positioned approximately within the open end 432b of the compression member 432, which is also approximately adjacent to the compression member 432. By “approximately within the within the open end 432b of the compression member 432” and “approximately adjacent to the compression member 432,” it is meant that the case cap adjusting member 443 is adapted to be positioned within the open end 432b of the compression member 432 with the cap adjuster flange portion 443e or the cap adjuster sheath portion 443f (or both) adjacent to the open end 432b and the adjoining interior surface of the compression member 432, respectively, but that other members, such as adjuster sealing means (which are described in more detail below) may be positioned between the outside surface 443a of the case cap adjusting member 443, on the one hand, and the open end 432b and adjacent interior surface of the compression member 432, on the other hand. The cap adjuster flange portion 443e and the cap adjuster sheath portion 443f may have another positioning and configuration in other embodiments, as may be necessary for the adjusting case cap member 443 to be operatively connected to the casing member 420 and to operatively engage the remaining components of the size adjusting means 440. In the illustrated embodiment, the outside surface 443a of the adjusting case cap member 443 generally has a size and shape so that it fits adjacent to the portion of the interior surface of the compression member 432 that is adjacent to the open end 432b of the compression member 432. In other embodiments, adjuster sealing means may be positioned between the exterior surface 443a of the case cap adjusting member 443 and the interior surface of the compression member 432, as described in more detail below. Also in the illustrated embodiment, the outside surface 443a of the cap adjuster sheath portion 443f is positioned approximately adjacent to the interior surface of the compression member 432, but this need not be the case in all embodiments. In the illustrated embodiment, the inside surface 443b of the adjusting case cap member 443 generally has a size and shape so that it fits adjacent to a portion of the exterior surface 441c of the adjusting compression member 441 that is adjacent to the open end of the adjusting compression member 441.

In the embodiment of the device 410 illustrated in FIG. 7 through FIG. 11, the device 410 is further comprised of adjuster sealing means for providing a fluid tight seal between the size adjusting means 440 and the casing member 420. In the illustrated embodiment, the adjuster sealing means are comprised of the case body adjusting member 442 (and in particular, the body adjuster flange portion 442a) being compressed against the open end 421d of the case body 421 as the case cap 423 is screwed onto the case body 421, so that a fluid-tight seal is adapted to be formed between the case body adjusting member 442 and the case body 421 at their interface. In other embodiments of the device 410, the adjuster sealing means may be comprised of any of the adjuster sealing means, such as washer 44 and adhesive layers with and without peel-off strips, which are described in more detail above and illustrated in connection with FIG. 1 through FIG. 6. In addition, the adjuster sealing means may be positioned in different locations relative to the case body adjusting member 442 or the case cap adjusting member 443 or both, on the one hand, and the casing member 420, on the other hand. The device 410 illustrated in FIG. 7 through FIG. 11 may be operated using substantially the same methods as are described above for the device 10 illustrated in FIG. 1 through FIG. 3, except that the second adjusting member (case cap adjusting member 443) is positioned approximately adjacent to the compression member 431, rather than directly against another surface of the case cap 423, as is the case with the case cap adjusting member 43 and the case cap 23 of the device 10 illustrated in FIG. 1 through FIG. 3.

The size adjusting means 540 illustrated in FIG. 12 through FIG. 16 represents yet another example of a different configuration of the size adjusting means 40, 440 illustrated in FIG. 1 through FIG. 11. In this embodiment, the size adjusting means 540 may be used with substantially any of the embodiments of the casing members 20, 420 described in more detail above and illustrated in connection with FIG. 1 through FIG. 11. Generally, the size adjusting means 540 are adapted to be positioned between a portion of the exterior surface of a second duct (not illustrated) and all or a portion of the casing member (not illustrated). Also in this embodiment, the size adjusting means 540 are comprised of a hollow adjusting compression member 541, a first adjusting member (case body adjusting member 542), a second adjusting member (case cap adjusting member 543), and adjuster sealing means, which are not illustrated, but which may be comprised of any of the adjuster sealing means described in more detail above and illustrated in connection with FIG. 1 through FIG. 11. The first adjusting member (case body adjusting member 542) and the second adjusting member (case cap adjusting member 543) generally have the same exterior shape and features as the first adjusting member (case body adjusting member 442) and second adjusting member (case cap adjusting member 443), respectively, described in more detail above and illustrated in connection with FIG. 7 through FIG. 11, so that they may be used with the casing member 420 described in more detail above and illustrated in connection with FIG. 7 through FIG. 11. In other embodiments, the first adjusting member (case body adjusting member 542) and the second adjusting member (case cap adjusting member 543) may have any other suitable exterior shape and characteristics, such as the exterior shape and characteristics of the first adjusting member (case body adjusting member 42) and the second adjusting member (case cap adjusting member 43), respectively, described in more detail above and illustrated in connection with FIG. 1 through FIG. 3, so that they may be used with the casing member 20 described in more detail above and illustrated in connection with FIG. 1 through FIG. 3. Similarly, except as described below, the first adjusting member (case body adjusting member 542) and the second adjusting member (case cap adjusting member 543) may generally have the same interior shape and features as the first adjusting members (case body adjusting members 42, 442) and the second adjusting members (case cap adjusting members 43, 443), respectively, described in more detail above and illustrated in connection with FIG. 1 through FIG. 11.

In this embodiment, however, the case cap adjusting member 543 is comprised of a cap adjuster flange portion 543e, a cap adjuster sheath portion 543f that extends from the cap adjuster flange portion 543e, and a cap adjuster holding portion 543g that is positioned at the distal end of the cap adjuster sheath portion 543f. The cap adjuster holding portion 543g has a channel 543h that is recessed into its interior surface. Also in this embodiment, the adjusting compression member 541 has the approximately tubular shape illustrated, with a ridge portion 541d extending circumferentially around its outside surface 541c. In this embodiment, the adjusting compression member 541 is preferably constructed of a rigid or semi-rigid material, and more preferably, is constructed of the same material as the case cap adjusting member 543. The ridge portion 541d of the adjusting compression member 541 is adapted to be positioned within the channel 543h of the case cap adjusting member 543, so that the adjusting compression member 541 is operatively connected to the case cap adjusting member 543. Thus, once the adjusting compression member 541 is positioned within the case cap adjusting member 543, the adjusting compression member 541 is not normally removed from the case cap adjusting member 543. Assuming use with a casing member having a structure, features, characteristics, functions and operation substantially the same as the casing member 420 described in more detail above and illustrated in connection with FIG. 7 through FIG. 11, as the case cap (not illustrated) is screwed onto the case body (not illustrated), the open end 541a of the adjusting compression member 541 impinges upon a portion of the inside surface 542d of the case body adjusting member 542. As the case cap is further screwed down onto the case body, the adjusting compression member 541 is adapted to be deflected radially inward by the inside surface 542d of the case body adjusting member 542, so that the interior surface of the adjusting compression member 541 is compressed against the exterior surface of the duct (not illustrated), forming a fluid-tight seal between the size adjusting means 540 and the duct. It is to be noted that in other embodiments, the adjusting compression member 541 may be operatively connected to the second adjusting member (case cap adjusting member 543), rather than the first adjusting member (case body adjusting member 542). In these embodiments, the interior features of the first adjusting member (case body adjusting member 542) and the second adjusting member (case cap adjusting member 543) may be reversed in order to accommodate proper operation of the size adjusting means 540.

The present invention also includes kits (not directly illustrated) that comprise various combinations of components of the present invention, such components being described in more detail elsewhere herein. For example, referring to the devices 10, 410 illustrated in FIG. 1 through FIG. 16 (and variations thereof also illustrated in all of such figures) as an example, a kit may comprise any embodiment of the compression connector 15, 415, any embodiment of the size adjusting means 40, 440, 540, and any embodiment of the adjuster sealing means, or any combination comprising one or more of the same. A kit may also comprise any combination of the components (adjusting compression member 41, 441, 541, case body adjusting member 42 142, 242, 442, 542, and case cap adjusting member 43, 343, 443, 543) comprising the size adjusting means 40, 440, 540 (and variations thereof illustrated in FIG. 1 through FIG. 16) and any combination thereof that also includes any embodiment of the adjuster sealing means. As another example, a kit may also comprise any combination of the components (adjusting compression member 41, 441, 541, case body adjusting member 42 142, 242, 442, 542, and case cap adjusting member 43, 343, 443, 543) comprising the size adjusting means 40, 440, 540 (and variations thereof illustrated in FIG. 1 through FIG. 16), and any combination of any embodiment of the components (case body 21, 421 and case caps 22, 23, 422, 423 in the illustrated embodiments) comprising the casing member 20, 420.

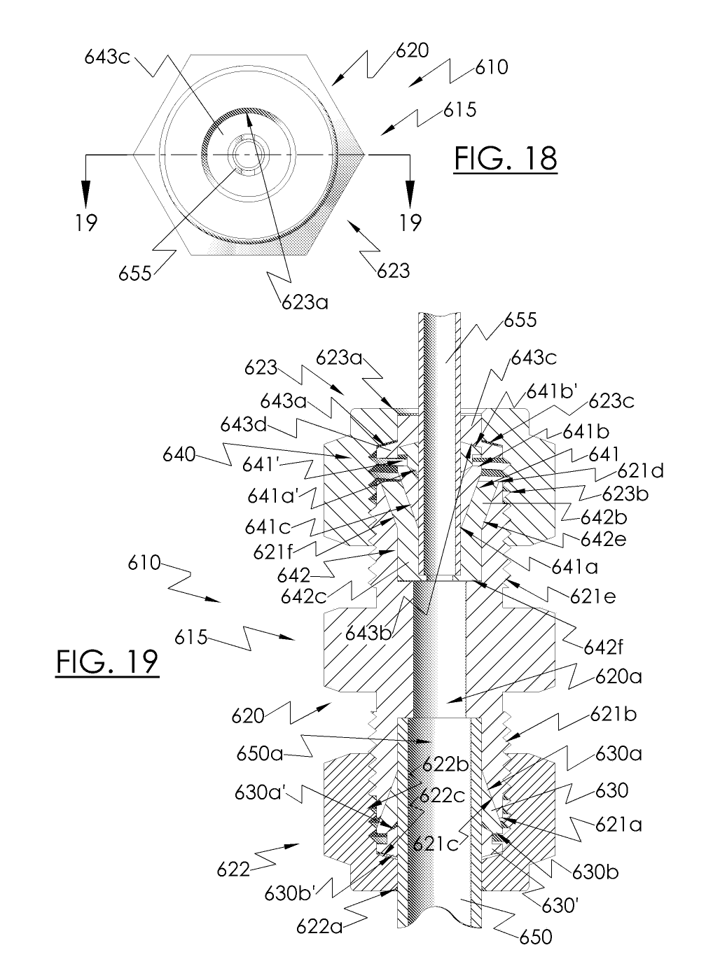

Yet another embodiment of the present invention is the device 610 illustrated in FIG. 17 through FIG. 21. FIG. 17 presents a partially exploded view of the device 610, FIG. 18 presents a plan view from above one end of the device 610, and FIG. 19 presents a sectional view of the device 610. In this embodiment, the device 610 is generally comprised of a compression connector 615, size adjusting means, and adjuster sealing means, all of which are described in more detail below. The compression connector 615 is further comprised of a casing member 620 and compression connecting means (first compression member 630 and second compression member 630′ in this embodiment), which are described in more detail below. The casing member 620 is further comprised of a case body 621, case caps 622, 623, and case cap connecting means (threads 621b, 621e, 622b, 623b in this embodiment), which are described in more detail below. The size adjusting means 640 are comprised of a two-piece adjusting compression member (first adjusting compression member 641 and second adjusting compression member 641′), a first adjusting member (case body adjusting member 642 in this embodiment), and a second adjusting member (case cap adjusting member 643 in this embodiment), all as described in more detail below. In some embodiments, as described in more detail below, the present invention may be comprised of the size adjusting means 640 alone, or the size adjusting means 640 (described in more detail below) in combination with the adjuster sealing means (the configuration of the exterior surface 642e of the case body adjusting member 642, the configuration of the interior surface 621f of the case body 621, and the compression of one 642e against the other 621f in this embodiment, as described in more detail below), the casing member 620 or the duct (pipe 655) or any of the same. The ducts (pipes 650, 655) may have any of the characteristics, features, structure, functions and operation as any of the ducts (pipes 50, 55) described in more detail above and illustrated in connection with FIG. 1 through FIG. 3.

In the embodiment of the device 610 illustrated in FIG. 17 through FIG. 21, the casing member 620 is further comprised of a hollow, approximately tubular-shaped case body 621 and a case cap 622, 623 positioned at each end of the case body 621. Casing member 620 and case caps 622, 623 may have any of the characteristics, features, structure, functions and operation as casing members 20, 420 and case caps 22, 23, 422, 423, respectively, as described in more detail above and illustrated in connection with FIG. 1 through FIG. 16. The case cap 622 has a duct opening 622a positioned therein that is of a size and shape adapted to receive the duct (pipe 650). The case cap 622 may be removably or permanently connected to the case body 621 by case cap connecting means, which may comprise any of the characteristics, features, structure, functions and operation as the case cap connecting means that may be used to connect casing members 20, 420 to case caps 22, 23, 422, 423, respectively, as described in more detail above and illustrated in connection with FIG. 1 through FIG. 16. In the embodiment of the device 610 illustrated in FIG. 17 through FIG. 21, the case cap 622 is approximately cylindrical in shape and may be attached to the open end 621a of the case body 621 adjacent to the case cap 622 by the threads 621b on the outside surface of the portion of the case body 621 adjacent to the open end 621a of the case body 621 and corresponding threads 622b on the interior surface of the tubular portion of the case cap 622. Thus, the case cap 622 may be placed over the open end 621a of the case body 621, and may then be screwed down onto the case body 621.

In the embodiment of the device 610 illustrated in FIG. 17 through FIG. 21, the hollow first compression member 630 is approximately frusto-conical in shape and is positioned between the second compression member 630′ and the case body 621. The second compression member 630′ is approximately annular in shape (as illustrated in FIG. 17 and FIG. 19) and is positioned between the first compression member 630 and the case cap 622. In other embodiments, the first compression member 630 and the second compression member 630′ may have other shapes, as long as they cooperate with the case cap 622 and the case body 621 to accommodate operation of the device 610, as described in more detail below. The first compression member 630 and the second compression member 630′ may have any of the characteristics, features, structure, functions and operation as compression members 30, 431, 432, as described in more detail above and illustrated in connection with FIG. 1 through FIG. 7, except as may be necessary to accommodate operation of the device 610, as described in more detail below. Thus, for example, the first compression member 630 and the second compression member 630′ may each be constructed from any of the materials and may be fabricated using any means appropriate for compression members 30, 431, 432, as described in more detail above and illustrated in connection with FIG. 1 through FIG. 7. Although the first compression member 630 and the second compression member 630′ are preferably constructed of the same material, they need not be constructed from the same material in every embodiment. In other embodiments, the first compression member 630 and the second compression member 630′ may be combined together as a single component.

In the embodiment of the device 610 illustrated in FIG. 17 through FIG. 21, the compression connecting means are comprised of the first compression member 630, the second compression member 630′, and the casing member 620 operating in a manner that utilizes compression between the casing member 620, the first compression member 630, the second compression member 630′, and the duct (pipe 650) in a manner adapted to form a fluid-tight seal between the compression connector 615 and the duct (pipe 650). In the illustrated embodiment, a portion of the interior surface 621c of the case body 621 located approximately adjacent to the case body open end 621a is adapted to be positioned adjacent to a portion of the exterior surface 630a of the first compression member 630. A portion of the surface 630a′ of the second compression member 630′ is adapted to be positioned adjacent to a portion of the exposed end 630b of the first compression member 630, while a portion of the surface 630b′ of the second compression member 630′ is adapted to be positioned adjacent to a portion of the interior surface 622c of the case cap 622. The duct (pipe 650) is positioned within the case body 621, the first compression member 630, the second compression member 630′, and the case cap 622, as best illustrated in FIG. 17 and FIG. 19. As the case cap 622 is screwed onto the case body 621, the interior surface 622c of the case cap 622 impinges against the surface 630b′ of the second compression member 630′. This causes the second compression member 630′ to be driven into the exposed end 630b of first compression member 630 and the duct (pipe 650). This action also typically causes the second compression member 630′ to hinge radially inward, gripping the duct (pipe 650) and thereby assisting in holding the duct (pipe 650) in place relative to the compression connector 615. In addition, the first compression member 630 is driven into the case body 621 and the duct (pipe 650), which is typically intended to create a fluid-tight seal between the case body 621 and the duct (pipe 650) within the designed operating pressures of the compression connector 615. The case cap 622 is typically screwed onto the case body 621 to an extent that causes the compression to be adequate to form the desired fluid-tight seal. Thus, when fluid is present within the interior space 620a of the casing member 620 and the interior space 650a of the duct (pipe 650), the fluid-tight connection between the case body 621, the first compression member 630, and the duct (pipe 650) holds the fluid within such interior spaces 620a, 650a of the casing member 620 and the duct (pipe 650), so that the fluid does not escape through the interfaces between the duct (pipe 650), the first compression member 630, and the case body 621.

In various embodiments of the device 610, the compression connector 615 may be comprised of almost any form of connector utilizing a two-piece compression connecting means. Generally, this means may include any connecting means that involves two members being compressed against the exterior surface of a duct to form a fluid-tight seal between the connector and the duct. In these cases, the fluid-tight seal may be created by compression of only one of the compression members 630, 630′, compression of both compression members 630, 630′, or compression of only a portion of one or both of the compression members 630, 630′, in each case against the casing member 620 and the duct (pipe 650). In the embodiment of the device 610 illustrated in FIG. 17 through FIG. 19, the compression connector 615 is generally in the configuration of a coupling, so that it can accommodate connection to two ducts (such as pipes 650, 655) simultaneously. In other embodiments, the compression connector 615 may be incorporated in a variety of ways in any standard types of fittings, which may be fabricated as a part of or be attached to the compression connector 615. For example, the compression connector 615 may be fabricated as a portion of a 45 degree or 90 degree elbow, in which compression connecting means may be located at either or both openings of the elbow or in combination with any other connecting means (such as an MIP or FIP connection). As yet another example, the compression connector 615 may be fabricated as a portion of a tee, in which compression connecting means may be located at one or more openings of the tee and in combination with any other connecting means (such as an MIP or FIP connection), each being positioned in various openings of the tee that receive ducts (such as pipes 650, 655). Similarly, the compression connector 615 may be formed to have substantially the same geometry and configuration of any type of fitting or connector that may be used to connect to ducts (such as unions, crosses, “Y” connectors, valves, bulkhead fittings, etc.), with compression connecting means positioned in openings designed to receive ducts in a variety of combinations in conjunction with any other connecting means. Thus, in various embodiments, the compression connector 615 may be used to connect to one or more ducts utilizing compression connecting means or other means or a combination of compression connecting means and such other means.

In the embodiment of the compression connector 615 illustrated in FIG. 17 through FIG. 19, the other open end 621d of the case body 621, the case cap 623 that is adapted to be connected to it 621, and the case cap connecting means used to connect the case cap 623 to the case body 621 may each have substantially the same structure, features, characteristics, functions and operation as the open end 621a of the case body 621, the case cap 622, and the related case cap connecting means, as described in more detail above and illustrated in connection with FIG. 17 through FIG. 19. As a result, the illustrated case cap 623 is approximately cylindrical in shape and may be permanently or removably attached to the open end 621d of the case body 621 adjacent to the case cap 623 by the case cap connecting means, which are comprised of threads 621e on the outside surface of the portion of the case body 621 adjacent to the open end 621d of the case body 621 and corresponding threads 623b on the interior surface of the tubular portion of the case cap 623 in this embodiment. Thus, the case cap 623 may be placed over the open end 621d of the case body 621, and may then be screwed down onto the case body 621. Compression members (not illustrated, but substantially the same as the first compression member 630 and the second compression member 630′ described in more detail above and illustrated in connection with FIG. 17 through FIG. 19) may be used to connect ducts (such as pipe 650) that are of the appropriate size to the end of the compression connector 615 located at case cap 623.

The compression connector 615, however, is generally adapted to be connected to one size of duct (pipe 650). Thus, if the user of the compression connector 615 attempts to connect the compression connector 615 to a second duct (such as pipe 655) that is smaller than the design size of duct (pipe 650), the first compression member 630 and the second compression member 630′ are generally too large to compress against the exterior surface of the second duct (such as pipe 655) in a manner that will form a fluid-tight seal between the second duct (such as pipe 655) and the compression connector 615. In such cases, the size adjusting means 640 and the adjuster sealing means (as described in more detail below) of the present invention may be used to connect the second duct (pipe 655) to the compression connector 615. Generally, the size adjusting means 640 are adapted to be positioned between a portion of the exterior surface of the second duct (pipe 655) and at least a portion of the casing member 620. The size adjusting means 640 are also adapted to form a fluid-tight seal between the exterior surface of the second duct (pipe 655) and the size adjusting means 640 in those cases where the second duct (pipe 655) has a smaller outside cross-sectional perimeter than the first duct (pipe 650), which first duct (pipe 650) is of the size and shape designed for use with the compression connector 615.

In the embodiment of the device 610 illustrated in FIG. 17 through FIG. 21, the size adjusting means 640 are comprised of a hollow two-piece adjusting compression member (first adjusting compression member 641 and second compression member 641′ in this embodiment), a first adjusting member (case body adjusting member 642 in this embodiment), and a second adjusting member (case cap adjusting member 643 in this embodiment). Enlarged supplemental views of the case body adjusting member 642 and the case cap adjusting member 643 are illustrated in FIG. 20 and FIG. 21, respectively. In the illustrated embodiment, a portion of the surface 641a′ of the second adjusting compression member 641′ is placed adjacent to the open end 641b of the first adjusting compression member 641 in a manner similar to the placement of a portion of the surface 630a′ of the second compression member 630′ adjacent to the open end 630b of the first compression member 630. The first adjusting compression member 641 and the second adjusting compression member 641′ may generally have any of the same structures, features, characteristics, functions, and operation as the first compression member 630 and the second compression member 630′, respectively, described in more detail above and illustrated in connection with FIG. 17 through FIG. 19, except that the size and shape of the first adjusting compression member 641 and the second adjusting compression member 641′ are such that they are adapted to be positioned adjacent to the exterior surface of the second duct (pipe 655), and to be compressed between the case body adjusting member 642, the case cap adjusting member 643, and the second duct (pipe 655), so that a fluid-tight seal is adapted to be formed between at least the case body adjusting member 642, the first adjusting compression member 641, and the second duct (pipe 655). In the illustrated embodiment, the first adjusting compression member 641 is approximately frusto-conical in shape and is comprised of two open ends 641a, 641b, each adjoining an interior space of the adjusting compression member 641. The first adjusting compression member 641 is also comprised of an exterior surface 641c. In the illustrated embodiment, the second adjusting compression member 641′ is approximately annular in shape (as best illustrated in FIG. 17 and FIG. 19) and is comprised of exterior surfaces 641a′, 641b′. In other embodiments, the first adjusting compression member 641 and the second adjusting compression member 641′ may have different shapes and configurations, such as any shape that may be used for the first compression member 630 and the second compression member 630′, respectively, as described in more detail above and illustrated in connection with FIG. 17 through FIG. 19. As another example, the first adjusting compression member 641 and the second adjusting compression member 641′ may instead be comprised of a single compression member, which may have substantially the same structure, features, characteristics, functions and operation as any of the compression members 30, 41, 431, 432, 441, 541, as described in more detail above and illustrated in connection with FIG. 1 through FIG. 16. In such cases, the surface 643b of the case cap adjusting member 643 and the interior surface 642d of the case body adjusting member 642 may have their configurations modified so that they cooperate with the different compression member 30, 41, 431, 432, 441, 541, as is the case with case body adjusting members 42, 142, 242, 442, 542, respectively, and case cap adjusting members 43, 343. 443, 543, respectively, as described in more detail above and illustrated in connection with FIG. 1 through FIG. 16. The first adjusting compression member 641 and the second adjusting compression member 641′ may generally be comprised of any material or materials that may comprise the first compression member 630 and the second compression member 630′, as described in more detail above and illustrated in connection with FIG. 17 through FIG. 19. Although the first adjusting compression member 641 and the second adjusting compression member 641′ are preferably constructed of the same material, they need not be constructed from the same material in every embodiment. The first adjusting compression member 641 and the second adjusting compression member 641′ may also be fabricated using any means that may be used to fabricate the first compression member 630 and the second compression member 630′, as described in more detail above and illustrated in connection with FIG. 17 through FIG. 19.

In the embodiment of the device 610 illustrated in FIG. 17 through FIG. 21, the first adjusting member (case body adjusting member 642 in this embodiment) is positioned between a portion of the casing member 620 and a portion of the first adjusting compression member 641 at one open end 641a of the first adjusting compression member 641. In the illustrated embodiment, the case body adjusting member 642 is comprised of an adjuster upper portion 642b, an adjuster sheath portion 642c that extends from the adjuster upper portion 642b, and a duct stop portion 642f, which has perimeter dimensions that allow for adequate fluid flow, but are small enough such that the duct (pipe 655) is not able to travel beyond the duct stop portion 642f into the interior space 620a of the case body 621. The duct stop portion 642f need not be present in all embodiments of the case body adjusting member 642, and in other embodiments the case body adjusting member 642 may also further comprise a flange portion (not illustrated), which may be similar to the flange portion 42a of the case body adjusting member 42, as is described in more detail above and illustrated in connection with FIG. 1 through FIG. 3. The case body adjusting member 642 is also comprised of an inside surface 642d and an outside surface 642e. In the illustrated embodiment, the case body adjusting member 642 is positioned approximately within the case body open end 621d, which is also approximately adjacent to the case body 621. By “approximately within the case body open end 621d” and “approximately adjacent to the case body 621,” it is meant that the case body adjusting member 642 is adapted to be positioned within the case body open end 621d with at least a portion of the adjuster upper portion 642b adjacent to the interior surface 621f adjoining the open end 621d of the case body 621, but that other members, such as adjuster sealing means (which are described in more detail below) may be positioned between the adjuster upper portion 642b and the open end 621d and interior surface 621f of the case body 621. Also in this embodiment, the adjuster upper portion 642b and the adjuster sheath portion 642c extend into the interior space 620a of the casing member 620. The adjuster upper portion 642b and the adjuster sheath portion 642c may have another positioning and configuration in other embodiments, as may be necessary for the adjusting case body member 642 to be operatively connected to the casing member 620 and to operatively engage the remaining components of the size adjusting means 640. For example, the adjusting case body member 642 may have a different length of adjuster sheath portion 642c, so that the adjuster sheath portion 642c is shorter than as illustrated in the case body adjusting member 642 illustrated in FIG. 17 and FIG. 19. Preferably, there is a gap between the duct stop portion 642f of the case body adjusting member 642 and the interior surface of the case body 621 facing the duct stop portion 642f, so that the case body adjusting member 642 is able to compress at least a small amount into the case body 621 to assist in forming a fluid-right seal between the adjuster upper portion 642b and the surface 621f of the case body 621. As another example, the case body adjusting member 642 may have a different shape, such as may be required to cooperate with a different embodiment of adjusting compression sealing means (i.e., different from first adjusting compression member 641 and second adjusting compression member 641′), as described in more detail above and illustrated in connection with FIG. 17 through FIG. 19.

In the illustrated embodiment, the outside surface 642e of the case body adjusting member 642 generally has a size and shape so that it fits adjacent to the portion of the interior surface 621f of the case body 621 that is adjacent to the open end 621d of the case body 621. In other embodiments, adjuster sealing means may be positioned between the exterior surface 642e of the case body adjusting member 642 and the interior surface 621f of the case body 621, as described in more detail below. Also in the illustrated embodiment, the outside surface 642e of the adjuster upper portion 642b and the adjuster sheath portion 642c is positioned approximately adjacent to the interior surface 621f and adjoining interior surfaces, respectively, of the case body 621, but this need not be the case in all embodiments. In the illustrated embodiment, the inside surface 642d of the case body adjusting member 642 generally has a size and shape so that it fits adjacent to a portion of the exterior surface 641c of the first adjusting compression member 641 that is adjacent to the open end 641a of the first adjusting compression member 641. The case body adjusting member 642 may be comprised of any suitable type of material. For example, the case body adjusting member 642 may be comprised of any of the materials that may comprise the case body adjusting members 42, 142, 242, 44, 542, as described above and illustrated in connection with FIG. 1 through FIG. 15. The case body adjusting member 642 may be fabricated using any suitable means. For example, the case body adjusting member 642 may generally be fabricated using any of the means that may be used to fabricate the case body adjusting members 42, 142, 242, 442, 542, as described above and illustrated in connection with FIG. 1 through FIG. 15.

In the embodiment of the device 610 illustrated in FIG. 17 through FIG. 21, the second adjusting member (case cap adjusting member 643 in this embodiment) is positioned between a portion of the casing member 620 and the second adjusting compression member 641′. In the illustrated embodiment, the case cap adjusting member 643 has a lofted portion 643c extending from a flange portion 643d, both of which are approximately annular in shape. The case cap adjusting member 643 is also comprised of a top surface 643a and a bottom surface 643b. In the illustrated embodiment, the case cap adjusting member 643 is positioned approximately within the duct opening 623a of the case cap 623, which is also approximately adjacent to the case cap 623. By “approximately within the duct opening 623a” and “approximately adjacent to the case cap 623,” it is meant that the case cap adjusting member 643 is adapted to be positioned within the duct opening 623a with the top surface 643a of the case cap adjusting member 643 positioned adjacent to the surfaces adjoining the duct opening 623a of the case cap 623, but that there may be a gap between such exterior surface 643a and the duct opening 623a or other members, such as adjuster sealing means (which are described in more detail below), may be positioned between the case cap adjusting member 643 and the duct opening 623a. It is to be noted that the case cap adjusting member 643 may have another positioning and configuration in other embodiments, as may be necessary for the case cap adjusting member 643 to be operatively connected to the case cap 623 and to operatively engage the remaining components of the size adjusting means 640. For example, the case cap adjusting member 643 may have a different shape, such as may be required to cooperate with a different embodiment of adjusting compression sealing means (i.e., different from first adjusting compression member 641 and second adjusting compression member 641′), as described in more detail above and illustrated in connection with FIG. 17 through FIG. 19. In the illustrated embodiment, the top surface 643a of the case cap adjusting member 643 generally has a size and shape so that it fits adjacent to the portion of the interior surface 623c of the case cap 623 that is adjacent to the duct opening 623a of the case cap 623. In other embodiments, adjuster sealing means may be positioned between the top surface 643a of the case cap adjusting member 643 and the interior surface 623c of the case cap 623, as described in more detail below. In the illustrated embodiment, the bottom surface 643b of the case cap adjusting member 643 generally has a size and shape so that it fits adjacent to a portion of exterior surface 641b′ of the second adjusting compression member 641′. The case cap adjusting member 643 may be comprised of any suitable type of material or materials that may comprise the case body adjusting member 642. Although the case body adjusting member 642 and the case cap adjusting member 643 need not be comprised of the same material, they are preferably comprised of the same material or materials. The case cap adjusting member 643 may be fabricated using any suitable means, such as any of the means that may be suitable for fabricating any of the case cap adjusting members 43, 343, 443, 543, as described in more detail above and illustrated in connection with FIG. 1 through FIG. 16.

The preferred configuration and material composition of the components comprising the embodiments of the device 610 are dependent upon a number of factors, such as the operating pressure of the device 610, the fluid carried by the ducts (pipes 650, 655), the size of the ducts (pipes 650, 655), the operating temperature of the device 610, the operating environment of the device 610, the preferences of the user of the device 610, and possibly other factors. It is to be noted that the preferred configuration and material composition of the components comprising devices 10, 410, 710, 810 are dependent upon similar factors. In the case of a compression connector 15 carrying high pressure gas in a relatively high pressure and high temperature environment, for example, the preferred material for fabrication of the compression connector 615 may be stainless steel. In such case, the casing member 620, first adjusting compression member 641, second adjusting compression member 641′, case body adjusting member 642, and case cap adjusting member 643 may all be constructed of stainless steel. On the other hand, for a compression connector 615 designed to be used with domestic potable water at relatively lower pressure and normal room temperature, the preferred material for fabrication of the compression connector 615 may be PVC. In such case, the casing member 620, first adjusting compression member 641, second adjusting compression member 641′, case body adjusting member 642, and case cap adjusting member 643 may all be constructed of PVC. In other operating conditions, it may be preferable for the various components comprising the compression connector 615 and the size adjusting means 640 to be constructed of different materials or combinations of materials.

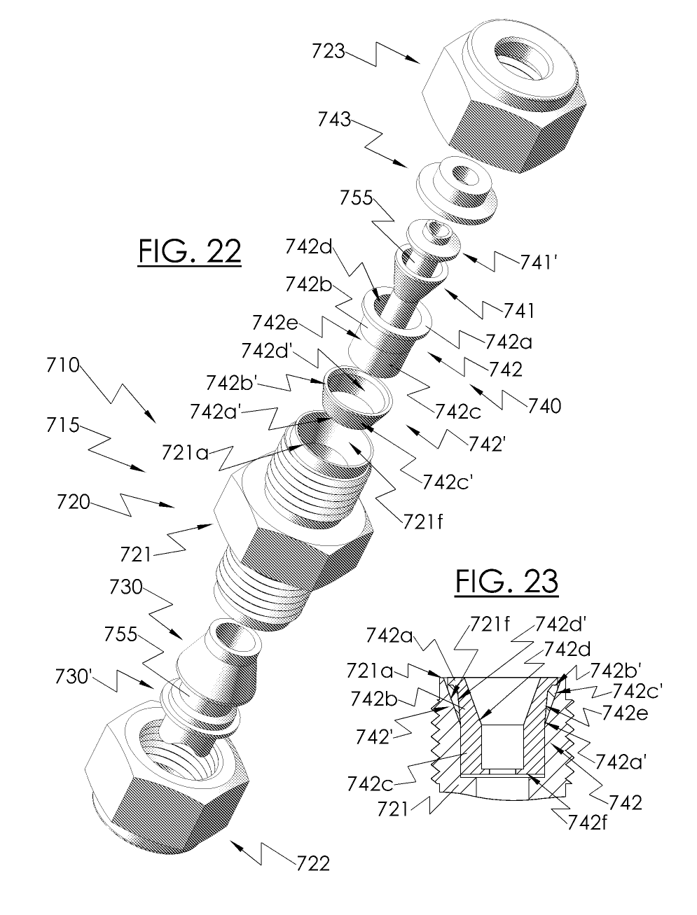

In the embodiment of the device 610 illustrated in FIG. 17 through FIG. 21, the device 610 is further comprised of adjuster sealing means for providing a fluid tight seal between all or a portion of the size adjusting means 640 and the casing member 620. In the illustrated embodiment, the adjuster sealing means are comprised of the force exerted by the exterior surface 642e of the case body adjusting member 642 against the interior surface 621f of the case body 621 when the case cap 623 is screwed down onto the case body 621. The configuration of the exterior surface 642e of the case body adjusting member 642 and the configuration of the interior surface 621f of the case body 621, both being frusto-conical, cause such surfaces 642e, 621f to be tightly compressed together so that a fluid-tight seal is created between them over the design operating pressures of the device 610. Although this is the preferred adjuster sealing means in this embodiment of the device 610, in other embodiments the adjuster sealing means may be comprised of any of the adjuster sealing means comprising any of the devices 10, 410 and component parts thereof, as described in more detail above and illustrated in connection with FIG. 1 through FIG. 16, either alone or in any combination thereof or in any combination with the adjuster sealing means illustrated in FIG. 17 through FIG. 19. For example, in the device 710 illustrated in FIG. 22 and FIG. 23, the adjuster sealing means are comprised of the case body adjusting member 742 and the sealing compression member 742′ operating in conjunction with the case body 721. In this embodiment, the compression connector 715 is substantially the same as the compression connector 615 illustrated in FIG. 17 through FIG. 19. Similarly, the size adjusting means 740 are substantially the same as the size adjusting means 640 illustrated in FIG. 17 through FIG. 19, except as described below. In the illustrated embodiment, the sealing compression member 742′ is comprised of two open ends 742a′, 742b′, a sealing compression member exterior surface 742c′, and a sealing compression member interior surface 742d′. The sealing compression member 742′ is positioned adjacent to the case body 721 so that the exterior surface 742c′ of the sealing compression member 742′ is adjacent to the frusto-conical-shaped portion of the interior surface 721f of the case body 721. The case body adjusting member 742 is comprised of an adjuster flange portion 742a, an adjuster flange transition portion 742b extending from the adjuster flange portion 742a, an adjuster sheath portion 742c extending from the adjuster flange transition portion 742b, and a duct stop portion 742g positioned at the distal end of the adjuster sheath portion 742c. The case body adjusting member 742 is also comprised of an adjuster interior surface 742d and an adjuster exterior surface 742e. The case body adjusting member 742 is positioned within the sealing compression member 742′ and the case body 721, so that the adjuster flange portion 742a of the case body adjusting member 742 is adjacent to the open end 742b′ of the sealing compression member 742′, the exterior surface 742e of the adjuster flange transition portion 742b is adjacent to the interior surface 742d′ of the sealing compression member 742′, and the exterior surface 742e of the adjuster sheath portion 742 is approximately adjacent to the cylindrically-shaped interior surface 721f of the case body 721. Preferably, there is a gap between the adjuster duct stop portion 742f and the facing interior surface of the case body 721 to allow for movement of the case body adjusting member 742 during the compression process that occurs when the case cap 723 is screwed onto the case body 721. The adjuster duct stop portion 742f is adapted to stop the travel of the duct (pipe 755) into the case body 721, while allowing for adequate fluid flow from the duct (pipe 755) to the case body 721. When the case cap 723 is screwed down onto the case body 721, force is transmitted by the case cap 723 through the case cap adjusting member 743, the second adjusting compression member 741′, and the first adjusting compression member 741, which is then transmitted to the case body adjusting member 742. This force causes the adjuster flange portion 742a to be forced against the open end 742b′ of the sealing compression member 742′, which causes the sealing compression member 742′ to be driven into the interior surface 721f of the case body 721 and the exterior surface 742e of the case body adjusting member 742, causing a fluid-tight seal to be created between the case body 721 and the case body adjusting member 742 over the design operating pressures of the device 710. The case body adjusting member 742 may have substantially the same structure, features, characteristics, functions and operation as the case body adjusting member 642, as described in more detail above and illustrated in connection with FIG. 17 through FIG. 21. The sealing compression member 742′ may have substantially the same structure, features, characteristics, functions and operation as the first adjusting compression member 641, as described in more detail above and illustrated in connection with FIG. 17 through FIG. 21. Thus, the case body adjusting member 742 and the sealing compression member 742′ may be comprised of any of the materials that comprise, and may be fabricated using any of the means used to fabricate, the case body adjusting member 642 and the first adjusting compression member 641, respectively, as described above and illustrated in connection with FIG. 17 through FIG. 21.

Referring to the device 610 illustrated in FIG. 17 through FIG. 21, the present invention also includes another method of using the size adjusting means 640 and the adjuster sealing means, which are described in more detail above. For example, the method may include positioning the cap adjusting member 643 approximately adjacent to the casing member 620 (approximately within the duct opening 623a of the case cap 623), positioning the case body adjusting member 642 approximately adjacent to the casing member 620 (approximately within the open end 621d of the case body 621, and including positioning any adjuster sealing means between the case body 621 and the case body adjuster member 642 where such means are utilized), positioning the first adjusting compression member 641 and the second adjusting compression member 641′ adjacent to one another, positioning the first adjusting compression member 641 adjacent to the case body adjusting member 642, and positioning the second adjusting compression member 641′ adjacent to the case cap adjusting member 643. These may be performed in any order. The duct (pipe 655) may then be inserted into the duct opening 623a of the case cap 623, so that the duct (pipe 655) is positioned within the size adjusting means 640 (comprising the case cap adjusting member 643, the first adjusting compression member 641, the second adjusting compression member 641′, and the case body adjusting member 642 in this embodiment). The method may further comprise compressing the first adjusting compression member 641 and the second adjusting compression member 641′ between the case cap adjusting member 643, the case body adjusting member 642, and the second duct (pipe 655), which occurs by screwing the case cap 623 onto the case body 621 in this embodiment, so that a fluid tight seal is adapted to be formed among at least the case body 621 (where adjuster sealing means are utilized), a portion of the size adjusting means 640 (e.g., the case body adjusting member 642 or the first adjusting compression member 641 or both), and the duct (pipe 655).

An example of another method of using the device 610 illustrated in FIG. 17 through FIG. 21 may comprise, in any order: (1) positioning the case cap 623, the case cap adjusting member 643, and the duct (pipe 655) adjacent to one another near one end of the duct (pipe 655), as illustrated in FIG. 19, and then positioning the first adjusting compression member 641 and the second compression adjusting member 641′ on the duct (pipe 655), as illustrated in FIG. 19; and (2) positioning the case body 621 adjacent to the case body adjusting member 642. The duct (pipe 655), the case cap adjusting member 643, the first adjusting compression member 641, and the second compression adjusting member 641′ may then be positioned adjacent to one another and the case body adjusting member 642. The method may further comprise compressing the first adjusting compression member 641 and the second adjusting compression member 641′ between the case cap adjusting member 643, the case body adjusting member 642, and the second duct (pipe 655), which occurs by screwing the case cap 623 onto the case body 621 in this embodiment, so that a fluid tight seal is adapted to be formed among at least the case body 621, the case body adjusting member 642, the first adjusting compression member 641, and the duct (pipe 655).

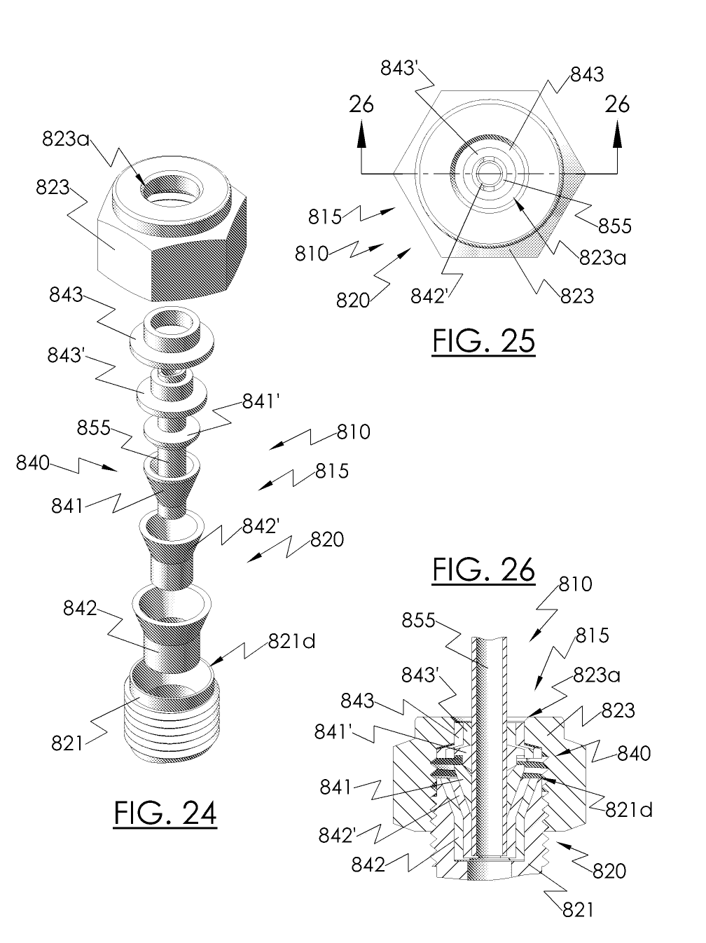

Another embodiment of the present invention is the device 810 illustrated in FIG. 24 through FIG. 26. This device 810 illustrates how the size adjusting means 840 may comprise two or more different sizes of size adjusting means (which may sometimes be referred to as “first” and “second” size adjusting means), as described in more detail below, which are utilized together in a single device. As an example for purposes of description of the device 810, assume that the casing member 820 is designed to accommodate connection to ducts (not illustrated) having an outside diameter of ½″. Also assume another smaller casing member (not illustrated) that is substantially identical to casing member 820, except that the smaller casing member is designed to accommodate connection to ducts (also not illustrated) having an outside diameter of ⅜″. Further assume that the second size adjusting means (comprising case body adjusting member 842 and the case cap adjusting member 843) are of a size and configuration adapted to be used with the casing member 820, which allows the casing member 820 to be connected to a duct (not illustrated) having an outside diameter of ⅜″. Further still, assume that the first size adjusting means (comprised of smaller case body adjusting member 842′ and the smaller case cap adjusting member 843′, as well as the first adjusting compression member 841 and the second adjusting compression member 841′), are of a size and configuration adapted to be used with the smaller casing member, and allow the smaller casing member to be connected to a duct (pipe 855) having an outside diameter of ¼″. In this embodiment, the case body 821, the case cap 823, the case body adjusting member 842, the case cap adjusting member 843, the smaller case body adjusting member 842′, the smaller case cap adjusting member 843′, the first adjusting compression member 841, and the second adjusting compression member 841′ may each have substantially the same structure, features, characteristics, functions and operation as the case body 621, the case cap 623, the case body adjusting member 642, the case cap adjusting member 643, the case body adjusting member 642, the case cap adjusting member 643, the first adjusting compression member 641, and the second adjusting compression member 641′, respectively, as described in more detail above and illustrated in connection with FIG. 17 through FIG. 21.

In the embodiment of the device 810 illustrated in FIG. 24 through FIG. 26, the smaller case body adjusting member 842′ may be positioned within the case body adjusting member 842, and the case body adjusting member 842 may be positioned within the case body 821 in substantially the same manner as the case body adjusting members 641, 741 may be positioned within the case bodies 621, 721, respectively, as described in more detail above and illustrated in connection with FIG. 17 through FIG. 23. Also in this embodiment, the smaller case cap adjusting member 843′ may be positioned within the case cap adjusting member 843, and the case cap adjusting member 843 may be positioned within the case cap 823 in substantially the same manner as the case cap adjusting members 643, 743 may be positioned within the case caps 623, 723, respectively, as described in more detail above and illustrated in connection with FIG. 17 through FIG. 23. The first adjusting compression member 841 and the second adjusting compression member 841′ are positioned adjacent to one another, as well as to the smaller case body adjusting member 742′ and the smaller case cap adjusting member 743′, respectively, in substantially the same manner as the first adjusting compression member 641 and the second adjusting compression member 641′ are positioned adjacent to one another and to the case body adjusting member 642 and the case cap adjusting member 643, respectively, as described in more detail above and illustrated in connection with FIG. 17 through FIG. 21.

In the illustrated embodiment, as the case cap 823 is screwed down onto the case body 821, the case cap adjusting member 843 is compressed against the smaller case cap adjusting member 843′. The smaller case cap adjusting member 843′ is compressed against the second adjusting compression member 841′, which is compressed against the first adjusting compression member 841, which is compressed against the smaller case body adjusting member 842′, all in substantially the same manner as the case cap adjusting member 643 is compressed against the second adjusting compression member 641′, which is compressed against the first adjusting compression member 641, which is compressed against the case body adjusting member 642, respectively, as described in more detail above and illustrated in connection with FIG. 17 through FIG. 21. The first adjusting compression member 841 also causes the smaller case body adjusting member 842′ to be compressed against the case body adjusting member 842, which is compressed against the case body 821. Thus, a fluid-tight seal is adapted to be created between the first adjusting compression member 841, the smaller case body adjusting member 842′, the case body adjusting member 842, and the case body 821 over the design operating pressures of the device 810 in substantially the same manner as the fluid-tight seal is created between the first adjusting compression member 641, the case body adjusting member 642, and the case body 621, as described in more detail above and illustrated in connection with FIG. 17 through FIG. 21. As a result, in order to allow a ½″ compression connector 815 to be connected to a ¼″ duct (pipe 855), the user of the device 810 may combine the second size adjusting means (case cap adjusting member 843 and case body adjusting member 842) designed to adapt a ½″ compression connector 815 to connect to a ⅜″ duct, and the first size adjusting means (smaller case cap adjusting member 843′, smaller case body adjusting member 842′, first adjusting compression member 841, and second adjusting compression member 841′) designed to adapt a ⅜″ compression connector to connect to a ¼″ duct, all in the manner illustrated. It is to be noted that more than two size adjusting means may be combined in other embodiments to form the size adjusting means 840 in substantially the same manner as is described above and illustrated in connection with FIG. 24 through FIG. 26. It is also to be noted that the various embodiments of the devices 10, 410 described above and illustrated in connection with FIG. 1 through FIG. 16 may also be adapted to provide for utilizing one or more combinations of different sizes of size adjusting means as a part of such devices 10, 410 in substantially the same type of manner as is illustrated in FIG. 24 through FIG. 26.

Referring to the device 810 illustrated in FIG. 24 through FIG. 26, the present invention also includes a method of using a size adjusting means 840 and adjuster sealing means, which are described in more detail above, that incorporate two or more different sizes of size adjusting means, as is the case with the first and second size adjusting means (described in more detail above) of the device 810 illustrated in FIG. 24 through FIG. 26. For example, the method may include positioning the cap adjusting member 843 approximately adjacent to the casing member 820 (approximately within the duct opening 823a of the case cap 823), positioning the case cap adjusting member 843 adjacent to the smaller case cap adjusting member 843′, positioning the case body adjusting member 842 approximately adjacent to the casing member 820 (approximately within the open end 821d of the case body 821, and including positioning any adjuster sealing means between the case body 821 and the case body adjuster member 842), positioning the case body adjusting member 842 adjacent to the smaller case body adjusting member 842′, positioning the first adjusting compression member 841 and the second adjusting compression member 841′ adjacent to one another, positioning the first adjusting compression member 841 adjacent to the smaller case body adjusting member 642′, and positioning the second adjusting compression member 841′ adjacent to the smaller case cap adjusting member 643′. These may be performed in any order. The duct (pipe 855) may then be inserted into the duct opening 823a of the case cap 823, so that the duct (pipe 855) is positioned within the size adjusting means 840 (comprising the case cap adjusting member 643, the smaller case cap adjusting member 643′, the first adjusting compression member 641, the second adjusting compression member 641′, the smaller case body adjusting member 642′, and the case body adjusting member 642 in this embodiment). The method further comprises compressing the first adjusting compression member 841 and the second adjusting compression member 841′ between the case cap adjusting member 843 and the smaller case cap adjusting member 843′, the case body adjusting member 642 and the smaller case body adjusting member 642′, and the duct (pipe 855), which occurs by screwing the case cap 823 onto the case body 821 in this embodiment, so that a fluid tight seal is adapted to be formed between the case body 821, at least a portion of the size adjusting means 840, and the duct (pipe 855).

The present invention also includes other kits (not directly illustrated) that comprise various combinations of components of the present invention, such components being described in more detail elsewhere herein. For example, referring to the devices 610, 710, 810 illustrated in FIG. 17 through FIG. 26 (and variations thereof also illustrated in all of such figures) as an example, a kit may comprise any embodiment of the compression connector 615, 715, 815, any embodiment of the size adjusting means 640, 740, 840, and any embodiment of the adjuster sealing means, as described in more detail above, or any combination comprising one or more of the same. A kit may also comprise any combination of the components (first adjusting compression member 641, 741, 841, second adjusting compression member 641′, 741′, 841′, case body adjusting member 642, 742, 842, smaller case body adjusting member 842′, case cap adjusting member 643, 743, 843, and smaller case cap adjusting member 843′) comprising the size adjusting means 640, 740, 840 (and variations thereof illustrated in FIG. 17 through FIG. 26) and any combination thereof that may also include any embodiment of the adjuster sealing means. As another example, a kit may also comprise any combination of the components (first adjusting compression member 641, 741, 841, second adjusting compression member 641′, 741′, 841′, case body adjusting member 642, 742, 842, smaller case body adjusting member 842′, case cap adjusting member 643, 743, 843, and smaller case cap adjusting member 843′) comprising the size adjusting means 640, 740, 840 (and variations thereof illustrated in FIG. 17 through FIG. 26), and any combination of any embodiment of the components (case body 621, 721, 821 and case caps 622, 623, 722, 723, 823 in the illustrated embodiments) comprising the casing member 620, 720, 820.

What is claimed is:

1. A device comprising:
(a) a casing member, wherein a compression connector is comprised of the casing member and at least one compression member, and the at least one compression member is adapted to be positioned between the casing member and a first duct, so that a fluid-tight seal is adapted to be formed between the compression connector and the first duct by compression of the at least one compression member between the exterior surface of the first duct and the casing member;
(b) size adjusting means adapted for being positioned between a portion of the exterior surface of a second duct and at least a portion of the casing member, and adapted for forming a fluid-tight seal between the exterior surface of the second duct and the size adjusting means, wherein the second duct has a smaller outside cross-sectional perimeter than the first duct and the size adjusting means are comprised of two hollow adjusting compression members adapted to be positioned adjacent to the exterior surface of the second duct; and
(c) adjuster sealing means for providing a fluid tight seal between the size adjusting means and the casing member.

2. The device of claim 1, wherein the size adjusting means are further comprised of:
(a) a hollow first adjusting compression member and a hollow second adjusting compression member positioned adjacent to one another, wherein the interior space of the hollow first adjusting compression member and the interior space of the hollow second adjusting compression member are each positioned adjacent to the exterior surface of the second duct;
(b) a first adjusting member positioned between a portion of the casing member and a portion of the first adjusting compression member; and
(c) a second adjusting member positioned between a portion of the casing member and a portion of the second adjusting compression member;
(d) wherein the first adjusting compression member and the second adjusting compression member are adapted to be compressed between the first adjusting member, the second adjusting member, and the second duct, so that a fluid-tight seal is adapted to be formed between at least the first adjusting member and the second duct.

3. A kit comprising all or any combination of the first adjusting compression member, the second adjusting compression member, the first adjusting member, and the second adjusting member of claim 2.

4. The device of claim 2, wherein:
(a) the casing member is further comprised of a case body having a casing interior space and comprising at least one case body open end adjoining the casing interior space, at least one case cap having a duct opening, and case cap connecting means for removably or permanently connecting the at least one case cap to the case body at the at least one case body open end;
(b) the first adjusting member is positioned between a portion of the case body and a portion of the first adjusting compression member; and
(c) the second adjusting member is positioned between a portion of the at least one case cap and a portion of the second adjusting compression member.

5. The device of claim 4, wherein the case cap connecting means are comprised of threads on a portion of the case body approximately adjacent to the at least one case body open end and corresponding threads on a surface of the at least one case cap, so that the at least one case cap is adapted to be screwed onto the case body at the at least one case body open end.

6. The device of claim 1, wherein:
(a) the casing member is further comprised of a case body having a casing interior space and comprising at least one case body open end adjoining the casing interior space, at least one case cap having a duct opening, and case cap connecting means for removably or permanently connecting the at least one case cap to the case body at the at least one case body open end; and
(b) the size adjusting means are further comprised of a first size adjusting means and a second size adjusting means, wherein:
(i) the first size adjusting means are adapted for forming a fluid-tight seal between the exterior surface of the second duct and the first size adjusting means; and
(ii) the second size adjusting means are comprised of a first adjusting member positioned between a portion of the case body and a portion of the first size adjusting means and adapted for forming a fluid-tight seal between at least a portion of the first adjusting member and a portion of the first size adjusting means, and a second adjusting member positioned between a portion of the case cap and a portion of the first size adjusting means.

7. A device comprising:
(a) a casing member, wherein a compression connector is comprised of the casing member, a first compression member, and a second compression member, and the first compression member and the second compression member are each adapted to be positioned between the casing member and a first duct, so that a fluid-tight seal is adapted to be formed between the compression connector and the first duct by compression of at least the first compression member between the exterior surface of the first duct and the casing member;
(b) size adjusting means adapted for being positioned between a portion of the exterior surface of a second duct and at least a portion of the casing member, and adapted for forming a fluid-tight seal between the exterior surface of the second duct and the size adjusting means, wherein the second duct has a smaller outside cross-sectional perimeter than the first duct; and
(c) adjuster sealing means for providing a fluid tight seal between the size adjusting means and the casing member.

8. The device of claim 7, wherein the adjuster sealing means are further comprised of a washer, gasket, o-ring, sealing compression member, or any combination thereof positioned between the size adjusting means and the casing member.

9. The device of claim 7, wherein the size adjusting means are further comprised of:
(a) a hollow adjusting compression member positioned adjacent to the exterior surface of the second duct, wherein the adjusting compression member is comprised of two open ends that each adjoin an interior space of the adjusting compression member;
(b) a first adjusting member positioned between a portion of the casing member and a portion of the adjusting compression member at one open end of the adjusting compression member; and
(c) a second adjusting member positioned between a portion of the casing member and a portion of the adjusting compression member at the other open end of the adjusting compression member;
(d) wherein the adjusting compression member is adapted to be compressed between the first adjusting member, the second adjusting member, and the second duct, so that a fluid-tight seal is adapted to be formed between the first adjusting member and the second duct.

10. A kit comprising the adjusting compression member, the case body adjusting member, and the case cap adjusting member of claim 9, or any combination thereof.

11. A method of using the device of claim 9, the method comprising:
(a) in any order:
(i) positioning the case cap adjusting member approximately adjacent to the casing member;
(ii) positioning the case body adjusting member approximately adjacent to the casing member; and
(iii) positioning the adjusting compression member adjacent to the second duct; and
(b) in any order:
(i) positioning the case cap adjusting member adjacent to the adjusting compression member; and
(ii) positioning the case body adjusting member adjacent to the adjusting compression member; and
(c) compressing the adjusting compression member between the case cap adjusting member, the case body adjusting member, and the second duct.

12. The device of claim 9, wherein:
(a) the casing member is further comprised of a case body having a casing interior space and comprising at least one case body open end adjoining the casing interior space, at least one case cap having a duct opening, and case cap connecting means for removably or permanently connecting the at least one case cap to the case body at the at least one case body open end;
(b) the second adjusting member is positioned between a portion of the case cap and a portion of the adjusting compression member; and
(c) the first adjusting member is positioned between a portion of the case body and a portion of the adjusting compression member.

13. A device adapted to assist in connecting a second duct to a compression connector, wherein the compression connector is comprised of a casing member and a compression member adapted to be positioned between the casing member and a first duct, so that a fluid-tight seal is adapted to be formed between the casing member and the first duct by compression of the compression member between the exterior surface of the first duct and the casing member, the device comprising:
(a) a hollow first adjusting compression member adapted to be positioned around the exterior surface of the second duct, wherein the second duct is of a smaller size than the first duct;
(b) a hollow second adjusting compression member adapted to be positioned adjacent to the first adjusting compression member and around the exterior surface of the second duct;
(c) a first adjusting member adapted to be positioned between a portion of the casing member and a portion of the first adjusting compression member; and
(d) a second adjusting member adapted to be positioned between a portion of the casing member and a portion of the second adjusting compression member;
(e) wherein the first adjusting compression member and the second adjusting compression member are adapted to be compressed between the first adjusting member, the second adjusting member, and the second duct, so that a fluid-tight seal is adapted to be formed between at least the first adjusting member and the second duct.

14. A kit comprising any combination of the first adjusting compression member, the second adjusting compression member, the first adjusting member, and the second adjusting member of claim 13.

15. The device of claim 13, further comprising adjuster sealing means adapted for forming a fluid-tight seal between the first adjusting member and the case body.

16. The device of claim 13, wherein:
(a) the casing member is further comprised of a case body having a casing interior space and comprising at least one case body open end adjoining the casing interior space, a case cap having a duct opening, and case cap connecting means for removably or permanently connecting the case cap to the case body at the at least one case body open end;
(b) the first adjusting member is comprised of a case body adjusting member adapted to be positioned between a portion of the case body and a portion of the first adjusting compression member; and
(c) the second adjusting member is comprised of a case cap adjusting member adapted to be positioned between a portion of the case cap and a portion of the second adjusting compression member.

17. A method of using the device of claim 16, the method comprising:
(a) in any order:
(i) positioning the cap adjusting member approximately adjacent to the case cap;
(ii) positioning the case body adjusting member approximately adjacent to the case body;
(iii) positioning the first adjusting compression member and the second adjusting compression member adjacent to one another;
(iv) positioning the first adjusting compression member adjacent to the case body adjusting member; and
(v) positioning the second adjusting compression member adjacent to the case cap adjusting member;
(b) inserting the second duct into the duct opening of the case cap, so that the second duct is positioned within the case cap adjusting member, the first adjusting compression member, the second adjusting compression member, and the case body adjusting member; and
(c) compressing the first adjusting compression member and the second adjusting compression member between the case cap adjusting member, the case body adjusting member, and the second duct in order to form a fluid-tight seal between at least the case body adjusting member and the second duct.

18. A device adapted to assist in connecting a second duct to a compression connector, wherein the compression connector is comprised of a casing member and at least one compression member adapted to be positioned between the casing member and a first duct, so that a fluid-tight seal is adapted to be formed between the casing member and the first duct by compression of the at least one compression member between the exterior surface of the first duct and the casing member, the device comprising:
(a) first size adjusting means adapted for forming a fluid-tight seal between the exterior surface of a second duct and the first size adjusting means, wherein the second duct has a smaller outside cross-sectional perimeter than the first duct;
(b) second size adjusting means adapted for being positioned between a portion of the first size adjusting means and a portion of the casing member, and adapted for forming a fluid-tight seal between at least a portion of the first size adjusting means and a portion of the second size adjusting means; and
(c) adjuster sealing means adapted for providing a fluid tight seal between the second size adjusting means and the casing member.

19. The device of claim 18, wherein:
(a) the first size adjusting means are further comprised of:
(i) a hollow first adjusting compression member and a hollow second adjusting compression member adapted to be positioned adjacent to one another, wherein the interior space of the hollow first adjusting compression member and the interior space of the hollow second adjusting compression member are each adapted to be positioned adjacent to the exterior surface of the second duct;
(ii) a first smaller adjusting member adapted to be positioned adjacent to at least a portion of the first adjusting compression member; and
(iii) a second smaller adjusting member adapted to be positioned adjacent to at least a portion of the second adjusting compression member;
(iv) wherein the first adjusting compression member and the second adjusting compression member are adapted to be compressed between the first smaller adjusting member, the second smaller adjusting member, and the second duct, so that a fluid-tight seal is adapted to be formed between at least the first smaller adjusting member and the second duct; and
(b) the second size adjusting means are further comprised of:
(i) a first larger adjusting member adapted to be positioned between a portion of the casing member and a portion of the first smaller adjusting member; and
(ii) a second larger adjusting member adapted to be positioned between a portion of the casing member and a portion of the second smaller adjusting compression member.

20. The device of claim 18, wherein:
(a) the first size adjusting means are further comprised of:
(i) a hollow adjusting compression member adapted to be positioned adjacent to the exterior surface of the second duct, wherein the adjusting compression member is comprised of two open ends that each adjoin an interior space of the adjusting compression member;
(ii) a first smaller adjusting member adapted to be positioned adjacent to a portion of the adjusting compression member at one open end of the adjusting compression member; and
(iii) a second smaller adjusting member adapted to be positioned adjacent to a portion of the adjusting compression member at the other open end of the adjusting compression member;
(iv) wherein the adjusting compression member is adapted to be compressed between the first smaller adjusting member, the second smaller adjusting member, and the second duct, so that a fluid-tight seal is adapted to be formed between at least the first smaller adjusting member and the second duct; and
(b) the second size adjusting means are further comprised of:
(i) a first adjusting member adapted to be positioned between a portion of the casing member and a portion of the first smaller adjusting member; and
(ii) a second adjusting member adapted to be positioned between a portion of the casing member and a portion of the second smaller adjusting compression member.
